(19) United States
(12) Patent Application Publication
(10) Pub. No.: US 2025/0081270 A1
(43) Pub. Date: Mar. 6, 2025

(54) TRANSMISSION SYSTEM, SWITCHING CONTROL APPARATUS, SWITCHING CONTROL METHOD AND PROGRAM

(71) Applicant: NIPPON TELEGRAPH AND TELEPHONE CORPORATION, Tokyo (JP)

(72) Inventors: Yuka OKAMOTO, Musashino-shi (JP); Tatsuya SHIMADA, Musashino-shi (JP); Yoshihito SAKAI, Musashino-shi (JP); Hirotaka UJIKAWA, Musashino-shi (JP); Kenji MIYAMOTO, Musashino-shi (JP); Hiroko NOMURA, Musashino-shi (JP)

(73) Assignee: NIPPON TELEGRAPH AND TELEPHONE CORPORATION, Tokyo (JP)

(21) Appl. No.: 18/697,561

(22) PCT Filed: Oct. 4, 2021
(86) PCT No.: PCT/JP2021/036632

§ 371 Date: Apr. 1, 2024

(51) Int. Cl. H04W 76/20; H04W 28/02; H04W 28/08; H04W 72/52

(52) U.S. Cl. CPC H04W 76/20; H04W 28/0284; H04W 28/0942; H04W 72/52

(57) ABSTRACT

A switching control apparatus calculates a traffic amount in a predetermined period of each first transmission apparatus that is a transmission apparatus of a predetermined layer on the basis of allocation of radio resources to a terminal that wirelessly transmits a signal to a lowermost transmission apparatus among a plurality of transfer apparatuses that constitute a communication network hierarchized into a plurality of layers and transfer a received signal to a layer next above. The switching control apparatus calculates a processing capability predicted to be required for each second transmission apparatus which is a transmission apparatus of a layer next above the first transmission apparatus on the basis of the traffic amount of the first transmission apparatus. The switching control apparatus instructs a transfer apparatus for transferring a signal transmitted from the first transmission apparatus to the second transmission apparatus to switch a connection destination of the first transmission apparatus under the control of the second transmission apparatus in which congestion is determined to occur on the basis of the processing capability.

### TECHNICAL FIELD

The present invention relates to a transmission system, a switching control apparatus, a switching control method and a program.

### BACKGROUND ART

In a mobile network (NW), a terminal is connected to an upper NW, such as the Internet, via an antenna station and a base station. When a base station is overloaded during communication of the terminal, the mobile NW distributes the load by switching a connection destination of the terminal to another base station having a small load. When such load distribution is performed, the terminal presents a switchable base station from among other base stations sharing available resources with a base station to which the terminal is connected.

FIG. 37 is a diagram illustrating load distribution of a mobile NW system of the related art. In an example illustrated in FIG. 37, the base station is separated into a distributed station and an aggregation station. The terminals 991a and 991b are connected to the aggregation station 994-1 through the antenna station 992-1 and the distributed station 993-1. The terminal 991c is connected to the aggregation station 994-2 via an antenna station 992-2 and the distributed station 993-2. When band tightness or overload occurs in the aggregation station 994-1, the terminal 991b presents the aggregation station 994-2 sharing the use resources with the aggregation station 994-1 as a base station to which the terminal 991b can be connected. A connection destination of the terminal 991b is changed to the aggregation station 994-2, so that a load can be distributed to the aggregation station 994-2 with a small load to which the terminal 991b can be connected.

Further, in recent years, virtualizing an aggregation station through base station virtualization and changing a virtualization aggregation station that is a connection destination according to a load have been proposed. FIG. 38 is a diagram illustrating load distribution of a mobile NW system using virtualization technology. The mobile NW system illustrated in FIG. 38 includes virtualization aggregation stations 995-1 and 995-2 in place of aggregation stations 994-1 and 994-2 illustrated in FIG. 37. The virtualization aggregation station 995-1 includes a base station controller 996-1, and aggregation stations 997-1-1 and 997-1-2. The virtualization aggregation station 995-2 includes a base station controller 996-2 and an aggregation station 997-2. The terminals 991a and 991b are connected to the aggregation station 997-1-1 through the antenna station 992-1 and the distributed station 993-1. The terminal 991b may change the connection destination to the aggregation station 997-1-2 or the aggregation station 997-2 due to band tightness or overload of the base station.

FIG. 39 is a sequence diagram of aggregation station switching processing in the mobile NW system of the related art. The mobile NW system switches the aggregation stations through processing of steps S901 to S914.

### CITATION LIST

### Non Patent Literature

[NPL 1] P. Szilagyi, et al., “Enhanced Mobility Load Balancing Optimisation in LTE,” 2012 IEEE 23rd International Symposium on Personal, Indoor and Mobile Radio Communications-(PIMRC), p. 997-1003, 2012. [NPL 2] “3GPP TS38.401,” 2021

### SUMMARY OF INVENTION

### Technical Problem

It is considered that, in the future, it is difficult to find a base station to which a terminal can be connected, while wide-band communication with a narrow coverage area such as millimeter waves increases. For example, in FIG. 37, the terminal 991b performs handover (HO) to the aggregation station 994-2 due to a load of the aggregation station 994-1 that is a connection destination. In this case, the terminal 991b switches connection to connect to the aggregation station 994-2 via the antenna station 992-2 and the distributed station 993-2. However, radio wave intensity of the terminal 991b may be low under the control of the antenna station 992-2. This causes problems such as a reduction in the amount of traffic that can be transmitted and a packet loss, which makes it difficult to realize low-delay communication. In addition, when base station switching, including up to the antenna station, is performed, it is necessary to instruct the terminal 991b to perform handover to the switching destination, and thus, a long time is required for a switching sequence.

Further, in the mobile NW system illustrated in FIG. 38, the terminal 991b may perform handover (HO) due to band tightness or overload of the base station. When the aggregation station is changed in the same hardware (HW) such as switching from the aggregation station 997-1-1 to the aggregation station 997-1-2, a lower station than the distributed station 993-1 may remain the same connection as before handover. This is because the base station controller 996-1 processes both the control signal of the aggregation station 997-1-1 and the control signal of the aggregation station 997-1-2.

On the other hand, in the case of load distribution between the aggregation stations having different base station controllers, transmission destinations of the control signals are different before and after the switching. Therefore, not only the aggregation station but also the antenna station with which the terminal performs radio communication should be switched. For example, the terminal 991b switches connection to the aggregation station 997-1-1 via the antenna station 992-1 and the distributed station 993-1 to connection to the aggregation station 997-2 via the antenna station 992-2 and the distributed station 993-2. However, the radio wave intensity of the terminal 991b may be low under the control of the antenna station 992-2. In such a case, the amount of traffic that can be transmitted is reduced. Further, since retransmission is performed due to the occurrence of a packet loss, it takes time to complete transmission of traffic. Thus, it is difficult to realize low delay communication (for example, 5 ms in a wired section).

Further, as illustrated in FIG. 39, in the case of aggregation station switching in the related art, a bearer change procedure can be performed between a base station controller (gNB-CU-CP) and an aggregation station (Source gNB-CU-UP) that is a switching source in steps S905 and S906, and then, a bearer change is performed between the base station controller (gNB-CU-CP) and an aggregation station (Target gNB-CU-UP) that is a switching destination in steps S907 and S908 so that bearer data transfer information can be exchanged. Further, the mobile NW system performs switching between the aggregation station and an upper optical path in step S910 after performing a switching procedure lower than the aggregation station. Therefore, it takes a long time from the start of the switching to the completion of the switching.

In view of the above circumstances, an object of the present invention is to provide a transmission system, a switching control apparatus, a switching control method and a program capable of reducing a delay caused by signal processing load balancing.

### Solution to Problem

A transmission system according to an embodiment of the present invention includes: a plurality of transmission apparatuses configured to constitute a communication network hierarchized into a plurality of layers and transfer a received signal to a layer next above; a transfer apparatus configured to transfer a signal transmitted from a first transmission apparatus serving as a transmission apparatus of a predetermined layer among the plurality of layers to a second transmission apparatus serving as a connection destination of the first transmission apparatus among the plurality of second transmission apparatuses serving as transmission apparatuses of a layer next above the predetermined layer; and a switching control apparatus configured to switch the second transmission apparatus serving as the connection destination of the first transmission apparatus, wherein the switching control apparatus includes a traffic amount calculator configured to calculate a traffic amount of a signal received via a transmission apparatus of a layer lower than the predetermined layer in a predetermined period by the first transmission apparatus, on the basis of allocation of radio resources to a terminal wirelessly transmitting a signal to a lowermost transmission apparatus; a required band calculator configured to calculate, for each second transmission apparatus, a processing capability predicted to be required in the second transmission apparatus on the basis of the traffic amount in the first transmission apparatus with the second transmission apparatus as a connection destination; a determiner configured to determine whether congestion occurs in the second transmission apparatus on the basis of the predicted processing capability; a switching determiner configured to determine that connection destinations of at least some of the first transmission apparatuses with the second transmission apparatus as a connection destination in which congestion is determined to occur are switched to the second transmission apparatus in which congestion is determined not to occur; and a switching instructor configured to instruct the transfer apparatus to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination of the switching determiner.

A switching control apparatus according to an embodiment of the present invention includes: a traffic amount calculator configured to calculate a traffic amount of a signal received via a transmission apparatus of a layer lower than a predetermined layer among a plurality of layers configured to constitute a communication network hierarchized into a plurality of layers and transfer a received signal to a layer next above, in a predetermined period by a first transmission apparatus serving as a transmission apparatus of the predetermined layer, on the basis of allocation of radio resources to a terminal wirelessly transmitting a signal to a lowermost transmission apparatus among the plurality of transmission apparatuses; a required band calculator configured to calculate, for each second transmission apparatus serving as a transmission apparatus of a layer higher the first transmission apparatus, a processing capability predicted to be required in the second transmission apparatus on the basis of the traffic amount in the first transmission apparatus with the second transmission apparatus as a connection destination; a determiner configured to determine whether or not congestion occurs in the second transmission apparatus on the basis of the predicted processing capability; a switching determiner configured to determine that connection destinations of at least some of the first transmission apparatuses with the second transmission apparatus in which congestion is determined to occur as a connection destination, are switched to the second transmission apparatus in which congestion is determined not to occur; and a switching instructor configured to instruct a transfer apparatus transferring a signal transmitted from the first transmission apparatus to the second transmission apparatus serving as the connection destination of the first transmission apparatus among the plurality of second transmission apparatuses to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination of the switching determiner.

A switching control method according to an embodiment of the present invention includes: traffic amount calculation step of calculating a traffic amount of a signal received via a transmission apparatus of a layer lower than a predetermined layer among a plurality of layers configured to constitute a communication network hierarchized into a plurality of layers and transfer a received signal to a layer next above, in a predetermined period by a first transmission apparatus serving as a transmission apparatus of the predetermined layer, on the basis of allocation of radio resources to a terminal wirelessly transmitting a signal to a lowermost transmission apparatus among the plurality of transmission apparatuses; a required band calculation step of calculating, for each second transmission apparatus serving as a transmission apparatus of a layer higher the first transmission apparatus, a processing capability predicted to be required in the second transmission apparatus on the basis of the traffic amount in the first transmission apparatus with the second transmission apparatus as a connection destination; a determination step of determining whether or not congestion occurs in the second transmission apparatus on the basis of the predicted processing capability; a switching determination step of determining to switch connection destinations of at least some of the first transmission apparatuses with the second transmission apparatus in which congestion is determined to occur as a connection destination, to the second transmission apparatus in which congestion is determined not to occur; and a switching instruction step of instructing a transfer apparatus transferring a signal transmitted from the first transmission apparatus to the second transmission apparatus serving as the connection destination of the first transmission apparatus among the plurality of second transmission apparatuses to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination in the switching determination step.

A program of one aspect of the present invention causes a computer to function as any one of the above-described switching control apparatuses.

### Advantageous Effects of Invention

According to the present invention, it is possible to reduce a delay caused by signal processing load balancing.

### BRIEF DESCRIPTION OF DRAWINGS

FIG. 1 is a diagram illustrating a configuration example of a mobile NW system according to an embodiment of the present invention.

FIG. 2 is a diagram illustrating a configuration example of a mobile NW system according to a first embodiment.

FIG. 3 is a functional block diagram illustrating a distributed station according to the first embodiment.

FIG. 4 is a functional block diagram illustrating an aggregation station according to the first embodiment.

FIG. 5 is a functional block diagram of a switching control apparatus according to the first embodiment.

FIG. 6 is a sequence diagram of the mobile NW system according to the first embodiment.

FIG. 7 is a flow diagram illustrating band control processing of the switching control apparatus according to the first embodiment.

FIG. 8 is a flow diagram illustrating traffic amount prediction model creation processing of a future traffic amount predictor according to the first embodiment.

FIG. 9 is a flow diagram illustrating the future traffic amount prediction processing of the future traffic amount predictor according to the first embodiment.

FIG. 10 is a flow diagram illustrating congestion determination processing of a determiner according to the first embodiment.

FIG. 11 is a flow diagram illustrating path switching control processing of the switching control apparatus according to the first embodiment.

FIG. 12 is a functional block diagram of a switching control apparatus according to a second embodiment.

FIG. 13 is a sequence diagram of a mobile NW system according to the second embodiment.

FIG. 14 is a flow diagram illustrating band control processing of the switching control apparatus according to the second embodiment.

FIG. 15 is a functional block diagram of a switching control apparatus according to a third embodiment.

FIG. 16 is a sequence diagram of a mobile NW system according to the third embodiment.

FIG. 17 is a flow diagram illustrating band control processing of the switching control apparatus according to the third embodiment.

FIG. 18 is a flow diagram illustrating required band prediction processing of a required band predictor according to the third embodiment.

FIG. 19 is a flow diagram illustrating time-series data generation processing of the required band predictor according to the third embodiment.

FIG. 20 is a flow diagram illustrating the required band prediction model generation processing of the required band predictor according to the third embodiment.

FIG. 21 is a flow diagram illustrating the required band prediction processing of the required band predictor according to the third embodiment.

FIG. 22 is a sequence diagram of the mobile NW system according to a fourth embodiment.

FIG. 23 is a sequence diagram of the mobile NW system according to the fourth embodiment.

FIG. 24 is a sequence diagram of the mobile NW system according to the fourth embodiment.

FIG. 25 is a diagram illustrating a configuration example of a mobile NW system according to a fifth embodiment.

FIG. 26 is a diagram illustrating a configuration example of a mobile NW system according to a sixth embodiment.

FIG. 27 is a diagram illustrating a configuration example of a mobile NW system according to a seventh embodiment.

FIG. 28 is a diagram illustrating some of slots of a radio signal between an antenna station and a terminal according to the seventh embodiment.

FIG. 29 is a functional block diagram of the switching control apparatus according to the seventh embodiment.

FIG. 30 is a sequence diagram of the mobile NW system according to the seventh embodiment.

FIG. 31 is a flow diagram illustrating band control processing of the switching control apparatus according to the seventh embodiment.

FIG. 32 is a flow diagram illustrating traffic amount prediction model creation processing of the future traffic amount predictor according to the seventh embodiment.

FIG. 33 is a flow diagram illustrating the future traffic amount prediction processing of the future traffic amount predictor according to the seventh embodiment.

FIG. 34 is a flow diagram illustrating congestion determination processing of a determiner according to the seventh embodiment.

FIG. 35 is a flow diagram illustrating path switching control processing of the switching control apparatus according to the seventh embodiment.

FIG. 36 is a diagram illustrating a hardware configuration of the switching control apparatus according to the first to seventh embodiments.

FIG. 37 is a diagram illustrating load distribution of a mobile NW system of the related art.

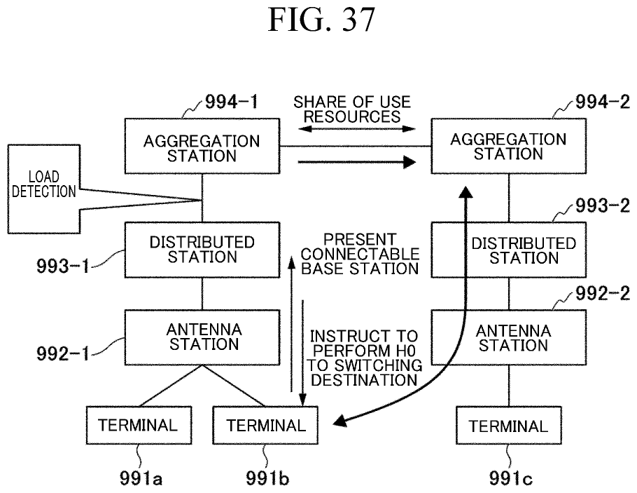

FIG. 38 is a diagram illustrating load distribution of a mobile NW system of the related art.

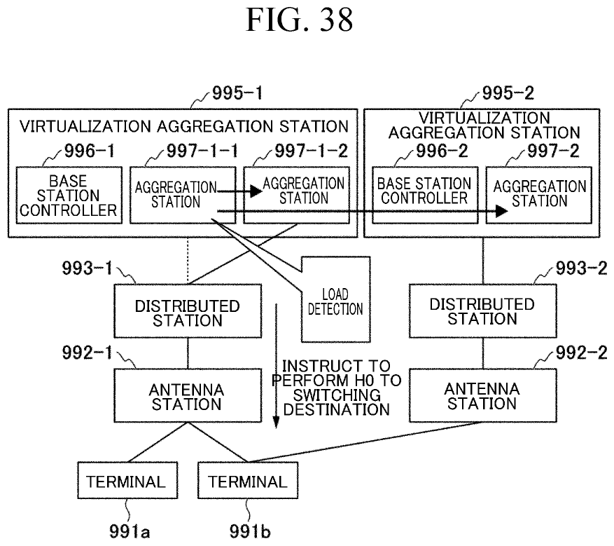

FIG. 39 is a CU switching sequence of the related art.

### DESCRIPTION OF EMBODIMENTS

Hereinafter, embodiments of the present invention will be described in detail with reference to the drawings. Parts having the same function are denoted by the same reference signs, and repeated description will be omitted.

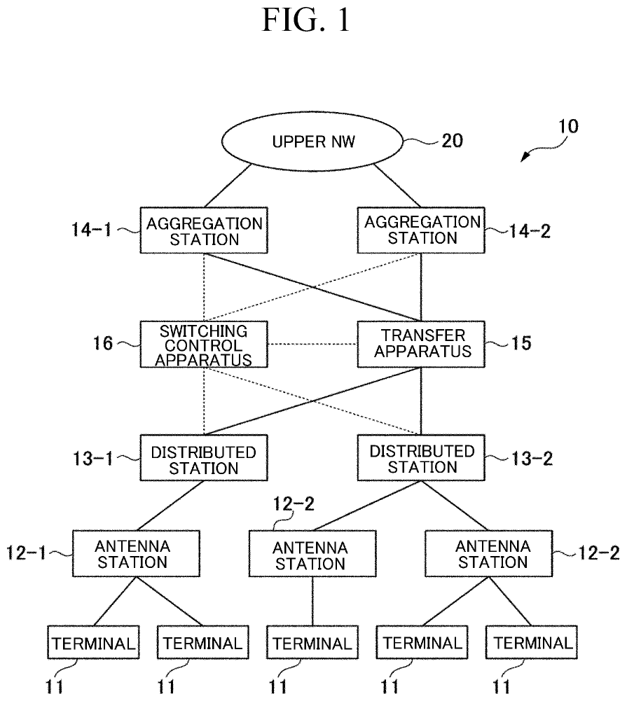

FIG. 1 is a diagram illustrating a configuration of a mobile NW system 10 according to an embodiment. The mobile NW system 10 is an example of a transmission system. The mobile NW system 10 is a 5th generation mobile NW system (hereinafter referred as “5G”). The mobile NW system 10 includes a terminal 11, an antenna station 12, a distributed station 13, an aggregation station 14, a transfer apparatus 15, and a switching control apparatus 16. The antenna station 12, the distributed station 13, and the aggregation station 14 are examples of a hierarchical transmission apparatus. The mobile NW system 10 is connected to the upper NW 20. M distributed stations 13 (M is an integer equal to or greater than 1) are described as distributed stations 13-1 to 13-M. Km (Km is an integer equal to or greater than 1) antenna stations 12 under the control of the distributed stations 13-m (m is an integer equal to or greater than 1 and equal to or smaller than M) are described as an antenna stations 12-m. Further, N (N is an integer equal to or greater than 2) aggregation stations 14 are described as aggregation stations 14-1 to 14-N. A direction from the terminal 11 to the upper NW 20 is described as uplink, and a direction from the upper NW 20 to terminal 11 is described as downlink.

The terminal 11 is, for example, a 5G user equipment (UE). The terminal 11 transmits or receives a radio signal to or from the antenna station 12 by using the radio resources allocated from the distributed station 13. The allocated radio resources include a start timing and an end timing of a time interval in which transmission and reception of a radio signal are permitted. The start timing and the end timing are represented by, for example, slots that are scheduling units of data transmission and reception in wireless frame. The allocated radio resources may further include a coding rate and a modulation scheme.

The antenna station 12 is, for example, a 5G (Radio Unit). The antenna station 12 receives uplink data through a radio signal from the terminal 11. The antenna station 12-m sets the received uplink data to an uplink signal and transmits the uplink signal to the distributed station 13-m by a wired interface. Furthermore, the antenna station 12-m receives the uplink signal from the distributed station 13-m using a wired interface. The antenna station 12 transmits downlink data addressed to the terminal 11 set in the received downlink signal addressed to the terminal 11 through a radio signal.

The distributed station 13 is, for example, a 5G distributed unit (DUT). The distributed station 13-m receives an uplink signal from each of Km the antenna stations 12-m. The uplink signal received by the distributed station 13-m includes uplink data that the antenna station 12-m has received from the terminal 11 under control. The distributed station 13 generates an uplink signal obtained by aggregating the uplink data, and transmits the generated uplink signal to the aggregation station 14 that is a connection destination of the own station. The distributed station 13 receives the downlink signal in which downlink data addressed to the terminal 11 under control has been set, from the aggregation station 14 that is a connection destination of the own station. The distributed station 13-m converts the received downlink signal into a downlink signal corresponding to a radio signal transmitted from each antenna station 12-m. The distributed station 13-m transmits the converted downlink signal to the antenna station 12-m corresponding to the downlink signal.

The aggregation station 14 is, for example, a 5G central unit (CU). The aggregation station 14 aggregates the uplink signals received from the distributed station 13 under control and transfers the uplink signals to an upper NW 20. The aggregation station 14 receives the downlink signal in which downlink data addressed to the terminal 11 has been set from the upper NW 20, and transfers the received downlink signal to the distributed station 13 connected to the destination terminal 11.

The transfer apparatus 15 is connected to the distributed station 13, the aggregation station 14, and the switching control apparatus 16. The transfer apparatus 15 transfers the uplink signal received from the distributed station 13 to the destination aggregation station 14 according to the transmission path. Further, the transfer apparatus 15 transfers the downlink signal received from the aggregation station 14 to the destination distributed station 13 according to the transmission path. The transmission path of the signal in the transfer apparatus 15 is instructed from the switching control apparatus 16.

The switching control apparatus 16 is connected to the distributed station 13, the aggregation station 14, and the transfer apparatus 15. The switching control apparatus 16 has a function of a 5G base station controller. Furthermore, the switching control apparatus 16 has a function of controlling switching of connection between the distributed station 13 and the aggregation station 14. The switching control apparatus 16 switches the aggregation station 14 that is a connection destination of the distributed station 13 to distribute a base station load according to a congestion situation or a load situation in the aggregation station 14. Specifically, the switching control apparatus 16 instructs the aggregation station 14 of a connection destination before switching (hereinafter referred to as a “switching source”) to release connection with the distributed station 13, and instructs the aggregation station 14 of a connection destination after switching (hereinafter referred to as a “switching destination”) to connect with the distributed station 13. Further, the switching control apparatus 16 instructs the transfer apparatus 15 to switch the transmission path for transfer of the signal through the path after the connection destination switching. In the following description, the change of the aggregation station that is a connection destination of the distributed station is described as “path switching”.

As described above, in the mobile NW system 10, the transfer apparatus 15 and the switching control apparatus 16 are disposed between the distributed station 13 and the aggregation station 14. The switching control apparatus 16 obtains information on signal processing capability of each aggregation station 14 connected to the transfer apparatus 15 and information on the amount of traffic generated from each distributed station 13 connected to the aggregation station 14. Since the mobile NW system 10 of the embodiment performs path switching on the basis of the uplink traffic, the traffic means the uplink traffic.

The switching control apparatus 16 receives information on the maximum processable band in advance as information on signal processing capability of the aggregation station 14. The maximum processable band is represented by a maximum buffer amount of the aggregation station 14 or the like. Further, the switching control apparatus 16 receives information from which a traffic amount in the next transmission period of the uplink signal can be acquired from each distributed station 13. Hereinafter, the transmission period of the uplink signal will be simply referred to as a “transmission period”. The switching control apparatus 16 performs load balancer (load distribution) according to the path switching when it is predicted that band tightness or an overload of processing occurs in the aggregation station 14 in the next or further next transmission period on the basis of the received information. The switching control apparatus 16 determines the aggregation station 14 that is a connection switching destination of the distributed station 13 so that band tightness and overload do not occur in any aggregation station 14. According to this determination, the switching control apparatus 16 performs path switching before a transmission period in which band tightness or an overload of processing is predicted to occur.

When the aggregation station 14 is virtualized, the switching control apparatus 16 receives information on resources allocated to the aggregation station 14 from a resource allocation apparatus (not illustrated) instead of receiving information on the maximum processable band from the aggregation station 14. The resource information indicates, for example, the number of cores of the CPU. The switching control apparatus 16 obtains information on the maximum processable band of the aggregation station 14 on the basis of the information on the number of cores. The processable band may be represented, for example, by the number of resource blocks. The resource block is a unit for allocating radio resources to the terminal 11.

The switching control apparatus 16 changes the connection between the aggregation station 14 and the distributed station 13 and then switches the transfer path of the transfer apparatus 15 when path switching is performed. This makes it possible to cope with band tightness or an overload of processing in all the aggregation stations 14, and to perform switching with low delay in which tightness hardly occurs at all times.

The mobile NW system 10 switches connection between the distributed station 13 and the aggregation station 14, but it is not necessary for the terminal 11 to perform handover for changing the antenna station 12 that is a connection destination. Therefore, low delay communication can be realized while avoiding the congestion. Furthermore, it is possible to use high-efficiency aggregation station resources while utilizing the mobile NW system 10 for large-capacity, low-delay communication or various services.

Hereinafter, detailed embodiments will be described.

### First Embodiment

In a first embodiment, the distributed station notifies the switching control apparatus of the traffic amount by using downlink control information (DCI) of 5G. The DCI includes scheduling information, data modulation, channel coding rate, and the like necessary for the terminal to transmit uplink data. The scheduling information is represented by a resource block. The resource block is represented by a channel, and transmission start timing and transmission end timing using the channel. The reception start timing and the reception end timing are represented by, for example, slots that are schedule units for transmitting and receiving data in 5G. In this case, the transmission end timing may be represented by the number of slots corresponding to the time elapsed from the transmission start timing.

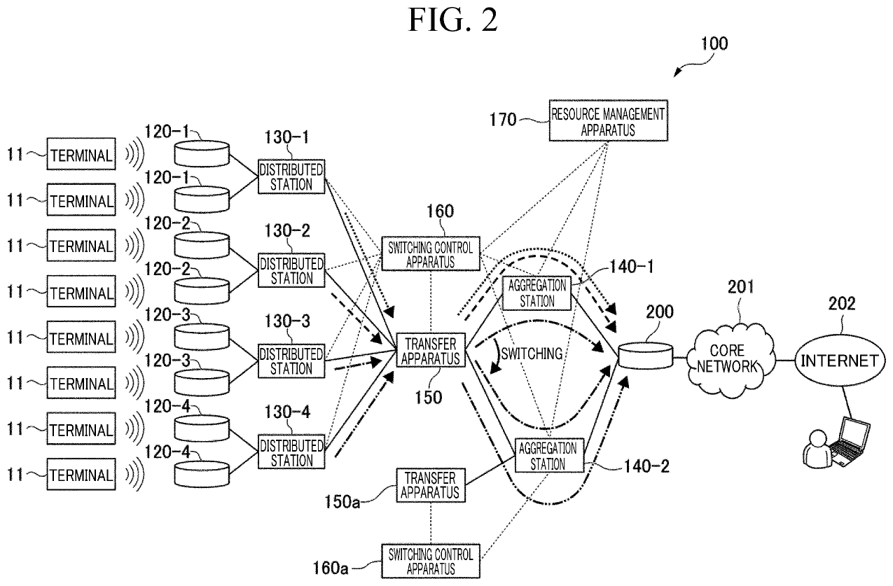

FIG. 2 is a diagram illustrating a configuration of a mobile NW system 100 according to the first embodiment. The mobile NW system 100 includes the terminal 11, an antenna station 120, the distributed station 130, the aggregation station 140, a transfer apparatus 150, a switching control apparatus 160, and a resource management apparatus 170. The antenna station 120, the distributed station 130, the aggregation station 140, the transfer apparatus 150, and the switching control apparatus 160 correspond to the antenna station 12, the distributed station 13, the aggregation station 14, the transfer apparatus 15, and the switching control apparatus 16 illustrated in FIG. 1. The antenna station 120, the distributed station 130, the aggregation station 140, the transfer apparatus 150, the switching control apparatus 160, and the resource management apparatus 170 constitute the mobile NW. The aggregation station 140 is connected to the core network 201 and the Internet 202 via the transfer apparatus 200. The transfer apparatus 200, the core network 201 and the Internet 202 correspond to the upper NW 20 in FIG. 1.

M distributed stations 130 (M is an integer equal to or greater than 1) are described as distributed stations 130-1 to 130-M. Km (Km is an integer equal to or greater than 1) antenna stations 120 under the control of the distributed station 130-m (m is an integer equal to or greater than 1 and equal to or smaller than M) are described as antenna stations 120-m. Further, N (N is an integer equal to or greater than 2) aggregation stations 140 are described as aggregation stations 140-1 to 140-N. FIG. 2 illustrates an example in which M=4, and K₁, K₂, K₃, K₄, and N=2.

Some of the aggregation stations 140-1 to 140-N may be connected to the transfer apparatus 150a and the switching control apparatus 160a. The transfer apparatus 150a and the switching control apparatus 160a have the same functions as those of the transfer apparatus 150 and the switching control apparatus 160. The transfer apparatus 150a and the switching control apparatus 160a are connected to the distributed station 130 and the aggregation station 140 not illustrated in FIG. 2. The resource management apparatus 170 manages resources of the aggregation stations 140.

The terminal 11, the antenna station 120, the distributed station 130, and the aggregation station 140 have 5G UE, RU, DU, and CU functions, respectively. The terminal 11 is connected to the Internet 202 via the antenna station 120, the distributed station 130, the transfer apparatus 150, the aggregation station 140, the transfer apparatus 200 and the core network 201. In the present embodiment, the bearer signal between the antenna station 120 and the distributed station 130, the bearer signal between the distributed station 130 and the aggregation station 140, and the signal between the aggregation station 140 and the transfer apparatus 200 are optical signals. The bearer signal is a signal in which user data transmitted or received by the terminal 11 is set. The core network 201 is an optical network.

The transfer apparatus 150 transfers the uplink signal received from the distributed station 130 to the destination aggregation station 140, and transfers the downlink signal received from the aggregation station 140 to the destination distributed station 130. When the bearer signal between the distributed station 130 and the aggregation station 140 is an optical signal, the transfer apparatus 150 is an optical gateway (GW). The optical GW includes a plurality of first ports (not illustrated) and a plurality of second ports (not illustrated). The first port is connected to a transmission path with the distributed station 130, and the second port is connected to a transmission path with the aggregation station 140. The optical GW outputs an optical signal at a predetermined wavelength input from any one of the first ports to any one of the second ports according to a preset path, and outputs an optical signal at a predetermined wavelength input from any one of the second ports to any one of the first ports according to a preset path. Wavelengths corresponding to the first ports and the second ports and a path between the first ports and the second ports are set according to an instruction from the switching control apparatus 160.

The switching control apparatus 160 receives the DCI information from the distributed station 130. The switching control apparatus 160 predicts a total traffic amount transmitted to each aggregation station 140 in the next transmission period on the basis of the DCI information. The aggregation station 140 may transmit information on the total traffic amount in the next transmission period to the switching control apparatus 160. Further, the switching control apparatus 160 receives information on the buffer amount buffered at the present time and bearer information from the aggregation station 140. The bearer information indicates the distributed station 130 to which the aggregation station 140 is connected. When the resource amount of the aggregation station 140 is fixed, the switching control apparatus 160 stores information on the maximum processable band of the aggregation station 140 calculated from the number of cores of the CPU of the aggregation station 140 in advance. When the resource amount of the aggregation station 140 changes, the resource management apparatus 170 transmits aggregation station resource information indicating the resource amount allocated to the aggregation station 140 to the switching control apparatus 160 periodically or when the resource amount changes. The switching control apparatus 160 calculates a current maximum processable band by using the resource amount of the aggregation station 140.

The switching control apparatus 160 determines a congestion degree of traffic of the aggregation station 140-n (n is an integer equal to or greater than 1 and equal to or smaller than N) or an overload state of processing by using a total traffic amount of the prediction transmitted to the aggregation station 140-n, the current buffer amount of the aggregation station 140-n and the maximum processable band. That is, the switching control apparatus 160 calculates the required band of the aggregation station 140-n by using the total traffic amount of prediction transmitted to the aggregation station 140-n. The required band is a band required for processing of the uplink traffic. In other words, the required band represents a demand traffic amount. When a sum of the required band and the current buffer amount is larger than the maximum processable band by a predetermined amount or more, the switching control apparatus 160 determines that congestion occurs because the band is tight or the processing enters an overload state. Band tightness occurs due to an increase in traffic, and the overload state of the processing occurs due to the shortage of resources of the aggregation station 140, that is, the shortage of the maximum processable band. When the switching control apparatus 160 determines that congestion occurs in the aggregation station 140-n, the aggregation station 140-n loads and balances traffic of at least some of the distributed stations 130 that is a connection destination to another aggregation station 140 in which the occurrence of congestion is not predicted.

When the distributed station 130 sets and deletes the connection to the terminal 11 when the distributed station 130 switches the aggregation station 140 that is a connection destination, it takes time for terminal connection, and low delay control becomes difficult. Therefore, the aggregation station 140 continues to have information on the connection to the terminal 11. Further, similarly, the aggregation station 140 also has the connection information of the base station.

The transfer apparatus 200 outputs an uplink signal input from a transmission path with the aggregation station 140 to the core network 201, and outputs a downlink signal input from the core network 201 to a transmission path with the aggregation station 140 that is a destination. When a signal between the aggregation station 140 and the transfer apparatus 200 is an optical signal, the transfer apparatus 200 is an optical GW or an optical SW (switch).

Some or all of the bearer signal between the antenna station 120 and the distributed station 130, the bearer signal between the distributed station 130 and the aggregation station 140, and the signal between the aggregation station 140 and the transfer apparatus 200 may not be optical signals. For example, when the bearer signal between the distributed station 130 and the aggregation station 140 is an electrical signal, the transfer apparatus 150 is a layer 2 switch or a router. Similarly, when the signal between the aggregation station 140 and the transfer apparatus 200 is an electrical signal, the transfer apparatus 200 is a router.

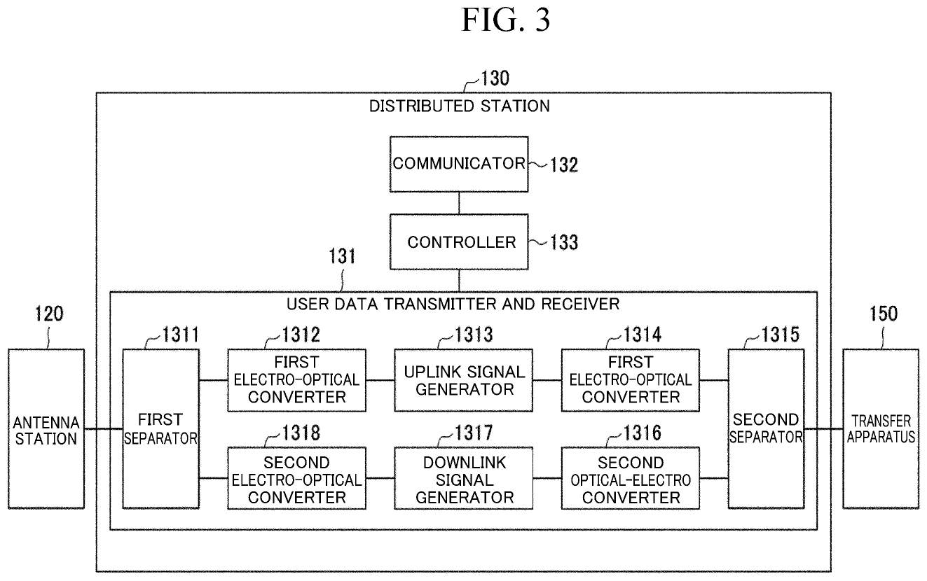

FIG. 3 is a functional block diagram illustrating an example of a functional configuration of the distributed station 130. Only functional blocks related to the present embodiment are extracted and illustrated in FIG. 3. The distributed station 130 includes a user data transmitter and receiver 131, a communicator 132, and a controller 133. The user data transmitter and receiver 131 transmits or receives a bearer signal of U-Plane. The user data transmitter and receiver 131 includes a first separator 1311, a first electro-optical converter 1312, an uplink signal generator 1313, a first electro-optical converter 1314, a second separator 1315, a second electro-optical converter 1316, a downlink signal generator 1317, and a second electro-optical converter 1318.

The first separator 1311 separates the uplink signal and the downlink signal according to a wavelength. The first separator 1311 outputs an uplink signal input from a transmission path with the antenna station 120 to the first electro-optical converter 1312, and outputs a downlink signal input from a second electro-optical converter 1318 to the transmission path with the antenna station 120. The first electro-optical converter 1312 converts the uplink signal from an optical signal to an electrical signal. The uplink signal generator 1313 generates an uplink signal addressed to the aggregation station 140 in which uplink data has been set, by performing protocol processing or header replacement on the uplink signal converted into the electrical signal. The first electro-optical converter 1314 converts the uplink signal addressed to the aggregation station 140 from an electrical signal to an optical signal and outputs the optical signal.

The second separator 1315 separates the uplink signal and the downlink signal according to a wavelength. The second separator 1315 outputs the uplink signal generated by the first electro-optical converter 1314 to a transmission path with the transfer apparatus 150, and outputs the downlink signal input from the transmission path with the transfer apparatus 150 to the second electro-optical converter 1316. The second electro-optical converter 1316 converts the downlink signal input from the second separator 1315 from an optical signal to an electrical signal. The downlink signal generator 1317 performs protocol processing or header replacement on the downlink signal converted into the electrical signal, thereby generating a downlink signal addressed to each antenna station 120 in which the downlink data acquired from the received downlink signal has been set. The second electro-optical converter 1318 converts the downlink signal addressed to each antenna station 120 generated by the downlink signal generator 1317 from an electrical signal to an optical signal, and then outputs the optical signal to the first separator 1311.

The communicator 132 transmits or receives communication data to or from other apparatuses such as the antenna station 120, the aggregation station 140, and the switching control apparatus 160. The control signal also includes a C-plane control signal. The controller 133 controls the entire distributed station 130 according to the control signal transmitted and received via the communicator 132. For example, the controller 133 switches the aggregation station 140 that is a connection destination according to the received control signal. Further, the controller 133 manages connection of a lower layer between the terminal 11 and the mobile NW system 100. The controller 133 controls, for example, protocol processing or header replacement processing in the user data transmitter and receiver 131 according to the terminal 11 connected to the antenna station 120 lower than the distributed station 130 or the aggregation station 140 that is a connection destination of the distributed station 130. The controller 133 may transmit the control signal through an optical signal. When the control signal is transmitted by an uplink optical signal, the uplink signal generator 1313 sets the control signal output by the controller 133 to the uplink signal. When the control signal is transmitted through a downlink optical signal, the downlink signal generator 1317 sets the control signal output by the controller 133 in an uplink signal. The control signal may be superimposed on an optical signal for transmitting the bearer signal, or may be transmitted through an optical signal different from the bearer signal. For example, the controller 133 sets, in the downlink signal, a control signal for the terminal 11. Through the control signal, the controller 133 transmits DCI indicating resources to be allocated to the terminal 11.

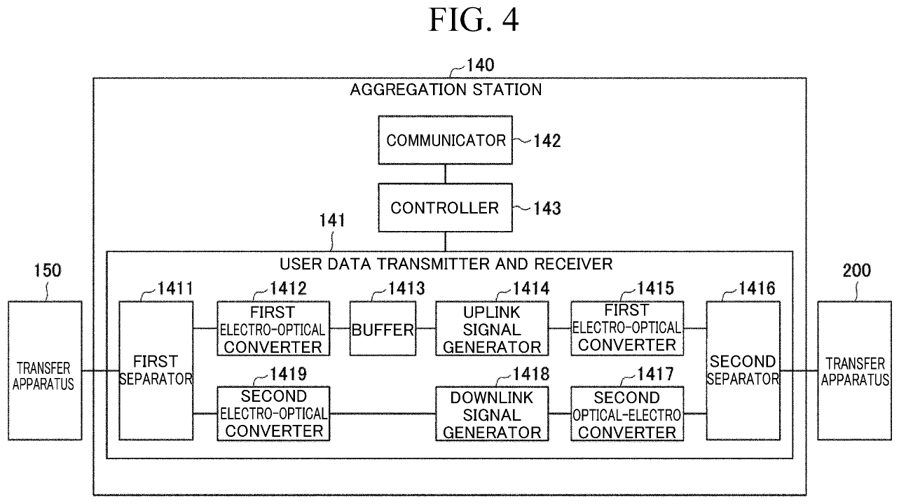

FIG. 4 is a functional block diagram illustrating a configuration example of the aggregation station 140. In FIG. 4, only functional blocks relating to the present embodiment are extracted and shown. The aggregation station 140 includes a user data transmitter and receiver 141, a communicator 142, and a controller 143. The user data transmitter and receiver 141 transmits or receives a bearer signal of U-Plane. The user data transmitter and receiver 141 includes a first separator 1411, a first electro-optical converter 1412, a buffer 1413, an uplink signal generator 1414, a first electro-optical converter 1415, a second separator 1416, a second electro-optical converter 1417, a downlink signal generator 1418, and a second electro-optical converter 1419.

The first separator 1411 separates the uplink signal and the downlink signal according to a wavelength. The first separator 1411 outputs the uplink signal input from the transmission path with the transfer apparatus 150 to the first electro-optical converter 1412, and outputs the downlink signal input from the second electro-optical converter 1419 to a transmission path with the transfer apparatus 150. The first electro-optical converter 1412 converts the uplink signal as an optical signal to an electrical signal. The buffer 1413 temporarily stores the uplink signal converted into the electrical signal by the first electro-optical converter 1412. The uplink signal generator 1414 reads the uplink signal from the buffer 1413, and generates an uplink signal addressed to the upper NW by performing protocol processing or header replacement. The first electro-optical converter 1415 converts the uplink signal generated by the uplink signal generator 1414 from an electrical signal to an optical signal and outputs the optical signal to the second separator 1416.

The second separator 1416 separates the uplink signal and the downlink signal according to a wavelength. The second separator 1416 transmits the uplink signal input from the first electro-optical converter 1415 to the transmission path with the transfer apparatus 200, and outputs the downlink signal received from the transmission path with the transfer apparatus 200 to the second electro-optical converter 1417. The second electro-optical converter 1417 converts the downlink signal input from the second separator 1416 from an optical signal to an electrical signal. The downlink signal generator 1418 performs protocol processing or header replacement on the downlink signal converted into the electrical signal, thereby generating a downlink signal addressed to each distributed station 130 in which the downlink data acquired from the received downlink signal is set. The second electro-optical converter 1419 converts the downlink signal addressed to each distributed station 130 generated by the downlink signal generator 1418 from an electrical signal to an optical signal, and then outputs the optical signal to the first separator 1411.

The communicator 142 transmits and receives control signals to and from other apparatuses such as the distributed station 130, the other aggregation station 140, the switching control apparatus 160, and a transfer apparatus 200. The control signal also includes a C-plane control signal. The controller 143 controls the entire aggregation station 140 according to the control signal transmitted and received via the communicator 142. For example, the controller 143 switches the distributed station 130 that is a connection destination according to the received control signal. The controller 143 controls a destination of the uplink signal and a destination of the downlink signal transmitted by the user data transmitter and receiver 141 according to the control signal. The controller 143 notifies the switching control apparatus 160 of the maximum processable band of the buffer 1413 and the current buffer amount through a control signal. When a buffer is provided at a stage behind the uplink signal generator 1414, the controller 143 may notify the switching control apparatus 160 of a maximum processable band of the buffer at the stage behind the uplink signal generator 1414 and the current buffer amount. The controller 143 may transmit a control signal through an optical signal. When the control signal is transmitted by an uplink optical signal, the uplink signal generator 1414 sets, in the uplink signal, the control signal output by the controller 143. When the control signal is transmitted through a downlink optical signal, the downlink signal generator 1418 sets, in the uplink signal, the control signal output by the controller 143. The control signal may be superimposed on the optical signal for transmitting the bearer signal, or may be transmitted by an optical signal different from the bearer signal.

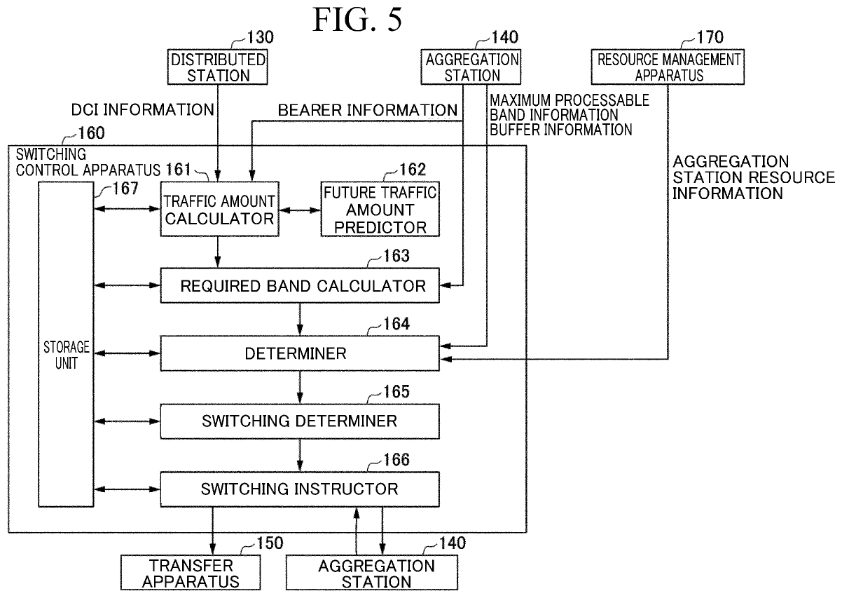

FIG. 5 is a block diagram illustrating a configuration of the switching control apparatus 160. The switching control apparatus 160 includes a traffic amount calculator 161, a future traffic amount predictor 162, a required band calculator 163, a determiner 164, a switching determiner 165, a switching instructor 166, and a storage 167.

The traffic amount calculator 161 calculates a predicted traffic amount of the next transmission period of each distributed station 130 by using the DCI information received from each distributed station 130. The DCI information may be DCI transmitted to the terminal 11, or may a part of data used for calculation of the uplink traffic amount in the next transmission period in the data set in the DCI. The predicted traffic amount in the next transmission period is the traffic amount predicted to be transmitted to the aggregation station 140 by the distributed station 130 in a transmission period next to the transmission period of the current uplink signal. The traffic amount calculator 161 calculates a predicted traffic amount in the next transmission period by using the DCI information for the next transmission period transmitted to the terminal 11. The future traffic amount predictor 162 predicts the future traffic amount of the distributed station 130. The future traffic amount is a predicted traffic amount in a transmission period next to the next transmission period.

The required band calculator 163 receives the bearer information from the aggregation station 140. The bearer information includes information on the distributed station 130 under control to which the aggregation station 140 is connected. The required band calculator 163 calculates the required band of each aggregation station 140 by using the predicted traffic amount of each distributed station 130 and the bearer information. When it is predicted that the path switching in the mobile NW system 100 is ended by the next transmission period, the predicted traffic amount used for calculation of the required band is the predicted traffic amount in the next transmission period calculated by the traffic amount calculator 161. When it is predicted that the path switching is not ended by the next transmission period, the predicted traffic amount used for calculation of the required band is the future traffic amount calculated by the future traffic amount predictor 162.

The determiner 164 calculates a congestion amount of each aggregation station 140 by using the required band of the aggregation station 140 calculated by the required band calculator 163 and information on the buffer amount and the maximum processable band received from the aggregation station 140. The determiner 164 may calculate the maximum processable band on the basis of the aggregated station resource information received from the resource management apparatus 170. The amount of data expected to be stored in the buffer can be used as the amount of congestion. Specifically, the congestion amount is calculated by subtracting the maximum processable band from the sum of the required band and the current buffer amount. The determiner 164 determines that the congestion is predicted when the congestion amount exceeds a threshold.

When the determiner 164 predicts the congestion, the switching determiner 165 determines the distributed station 130 for connection destination switching and the aggregation station 140 that is a switching destination so that the congestion amount in all the aggregation stations 140 is equal to or smaller than a predetermined amount on the basis of the required band and the congestion amount of each aggregation station 140 and the predicted traffic amount of each distributed station 130.

The switching instructor 166 instructs each apparatus to switch a path so that an uplink signal from the distributed station 130 to which the connection destination is to be switched is transferred to the aggregation station 140 that is a switching destination before the start of the transmission period in which congestion is predicted. Various types of data to be used for processing of each unit are stored in the storage 167.

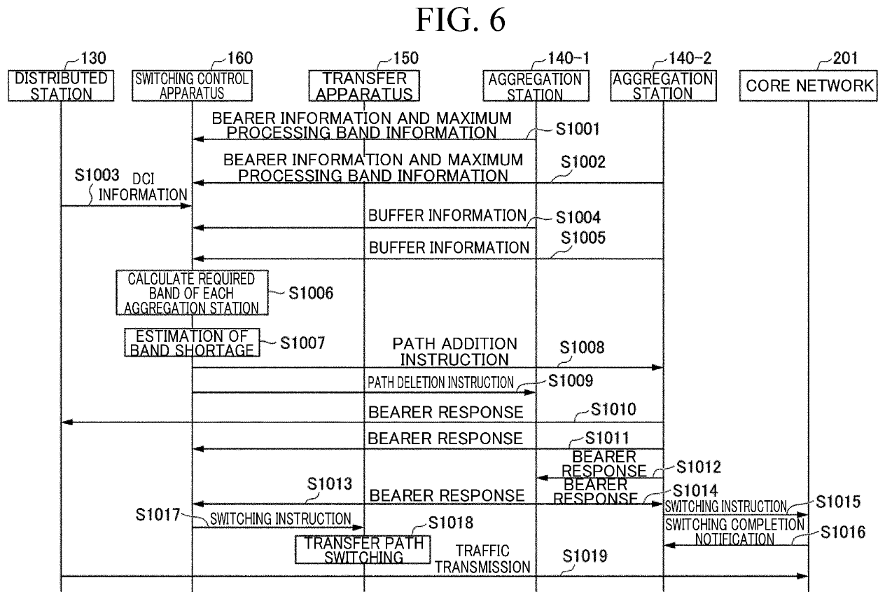

FIG. 6 is a sequence diagram illustrating a path switching procedure of the wireless mobile NW system 100. The controller 143 of each of the aggregation stations 140-1 and 140-2 notifies the switching control apparatus 160 of bearer information indicating the distributed station 130 to which the own station is connected and maximum processable band information indicating the maximum processable band in the own station (steps S1001 and S1002). The resource management apparatus 170 may transmit bearer information of the aggregation stations 140-1 and 140-2 to the switching control apparatus 160. When the aggregation station 140 is virtualized, the resource management apparatus 170 transmits the aggregation station resource information of each aggregation station 140 instead of the aggregation station 140 transmitting the maximum processable band information.

The controller 133 of each distributed station 130 transmits information on DCI transmitted to the terminal 11 as a scheduling result of the uplink signal to the switching control apparatus 160 (step S1003). Each time the distributed station 130 transmits the DCI to the terminal 11, the distributed station 130 notifies the switching control apparatus 160 of the DCI information. A frequency of the notification of the DCI information corresponds to a transmission time interval (TTI), but the TTI can be made variable in 5G. On the other hand, the controller 143 of each of the aggregation stations 140-1 and 140-2 notifies the switching control apparatus 160 of buffer information indicating a buffer amount of the own station (steps S1004 and S1005).

The switching control apparatus 160 calculates a predicted traffic amount in each distributed station 130 on the basis of the received the DCI information. The switching control apparatus 160 calculates the required band of each aggregation station 140 by summing the predicted traffic amounts of the distributed stations 130 connected to the aggregation station 140 for each aggregation station 140 (step S1006).

The switching control apparatus 160 calculates the congestion amount of each aggregation station 140 on the basis of the maximum processable band and the current buffer amount of each aggregation station 140 and the required band of each aggregation station 140 calculated in step S1006. The switching control apparatus 160 estimates the presence or absence of the band shortage of each aggregation station 140 by using the congestion amount (step S1007). The switching control apparatus 160 estimates that the band of the aggregation station 140-1 is insufficient.

The switching control apparatus 160 selects the aggregation station 140-2 estimated not to be in the band shortage as an offload destination. The switching control apparatus 160 selects the distributed station 130 whose connection destination is changed to the aggregation station 140-2 from some or all of the distributed stations 130 connected to the aggregation station 140-1. The selected distributed station 130 is described as the distributed station 130 that is a switching target. In order to offload the traffic of the distributed station 130 that is a switching target, the switching control apparatus 160 transmits a path addition instruction to the aggregation station 140-2 that is an offload destination (switching destination) (step S1008), and notifies the aggregation station 140-1 of an offload source (switching source) of the path deletion instruction (step S1009). The path addition instruction instructs to use an available band of the aggregation station 140-2 of the offload destination in order to receive traffic from the distributed station 130 that is a switching target. The path deletion instruction instructs to delete a band for receiving traffic from the distributed station 130 that is a switching target from an overload band of the aggregation station 140-1 that is an offload source. As the path addition instruction and the path deletion instruction, a bearer change instruction of a bearer context modification request is used. When the path addition instruction and the path deletion instruction are performed, the switching control apparatus 160 always keeps the F1 UE context between the antenna station 120 and the distributed station 130 in an established state.

When the controller 143 of the aggregation station 140-2 adds the band for receiving traffic from the distributed station 130 that is a switching target to the first separator 1411 according to the path addition instruction, the controller 143 of the aggregation station 140-2 transmits a bearer response to the distributed station 130 that is a switching target, the switching control apparatus 160, and the aggregation station 140-1 (step S1010, step S1011, and step S1012). On the other hand, when the controller 143 of the aggregation station 140-1 deletes the band for receiving traffic from the distributed station 130 that is a switching target from the first separator 1411 according to the path deletion instruction, the controller 143 transmits the bearer response to the switching control apparatus 160 and the aggregation station 140-2 (step S1013, step S1014). For the bearer response, a bearer context modification response is used.

The aggregation station 140-2 transmits an instruction to switch a signal transfer path to the core network 201 with the reception of the bearer response from the aggregation station 140-1 as a trigger (step S1015). The core network 201 switches the signal transfer path according to the switching instruction received from the aggregation station 140-2. The core network 201 switches a transfer path for changing a transfer source of an uplink signal in which uplink data from the terminal 11 under the control of the distributed station 130 that is a switching target has been set from the aggregation station 140-1 to the aggregation station 140-2. Further, the core network 201 switches a transfer path for changing a transfer destination of a downlink signal in which downlink data to the terminal 11 under the control of the distributed station 130 that is a switching target has been set, to the aggregation station 140-2. The core network 201 transmits a switching completion notification to the aggregation station 140-2 (step S1016).

The switching control apparatus 160 transmits an instruction to switch a transfer path to the transfer apparatus 150 with the reception of the bearer response information from the aggregation station 140-1 as a trigger (step S1017). The switching instruction is an instruction to change the transfer path so that an optical signal input from the first port to which a transmission path with the distributed station 130 that is a switching target is connected is output to the second port to which a transmission path with the aggregation station 140-2 is connected. The transfer apparatus 150 switches the transfer path according to the received switching instruction (step S1018). After the switching, the transfer apparatus 150 outputs the traffic of the uplink signal output by the distributed station 130 that is a switching target to the aggregation station 140-2 (step S1019).

As described above, in the present embodiment, the switching control apparatus 160 transmits a bearer change instruction as the path addition instruction and a bearer change instruction as the path deletion instruction to the aggregation station 140 (steps S1008 and S1009). The aggregation station 140 receiving the bearer change instruction changes the setting of the bearer according to the instruction. The aggregation station 140 that is a switching destination further transmits an instruction to switch the optical path to the upper apparatus (step S1015). The aggregation station 140 that is a switching destination receives the bearer response (step S1014) for notifying completion of the setting change of the bearer from the aggregation station 140 that is a switching source, and immediately transmits the switching instruction. Thus, it is possible to shorten a switching time when viewed from End to End. Furthermore, switching in the upper apparatus is likely to be completed during the path switching processing between the distributed station 130 and the aggregation station 140.

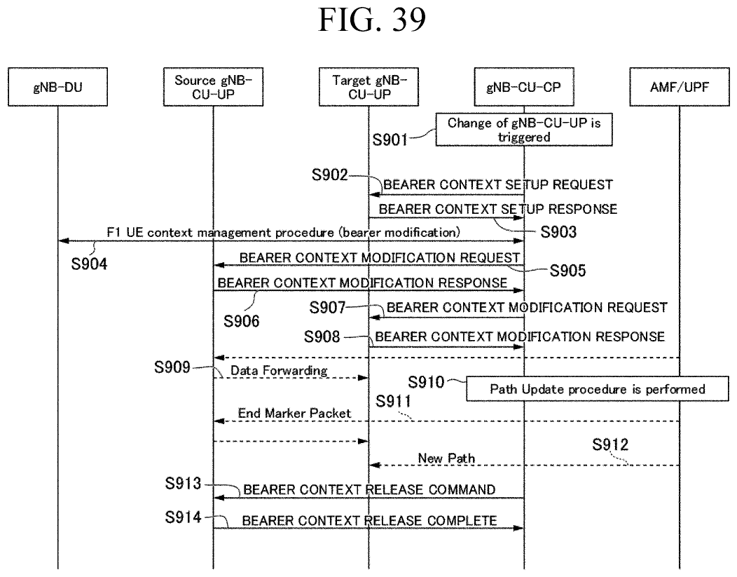

Further, in the above procedure, the aggregation station 140 that is a switching source performs the bearer change procedure according to the path deletion instruction (step S1009), and the aggregation station 140 that is a switching destination performs a bearer setting procedure according to the path addition instruction (step S1008). Response information of the bearer is transmitted from the aggregation station 140 that is a switching source to the aggregation station 140 that is a switching destination (step S1014), and response information of the bearer is transmitted from the aggregation station 140 that is a switching destination to the aggregation station 140 that is a switching source (step S1012). Thus, the data transfer information of the bearer can be exchanged, and the switching can be performed at a high speed as compared with the switching of the related art illustrated in FIG. 39.

Further, the switching control apparatus 160 receives the bearer responses of the aggregation station 140 that is a switching destination and the aggregation station 140 that is a switching source, and then transmits a switching instruction to the transfer apparatus 150 (step S1017). Thus, there is no problem that the reception of the data transfer information is not completed.

Further, the bearer response is transmitted from the aggregation station 140 that is a switching destination to the distributed station 130 (step S1010), so that a setting between the distributed station 130 and the aggregation station 140 can be quickly changed. It is assumed that the distributed station 130 has acquired information on connection (F1 UE connection) to a neighboring aggregation station 140 in advance at the time of connection to the aggregation station 140 that is a switching source.

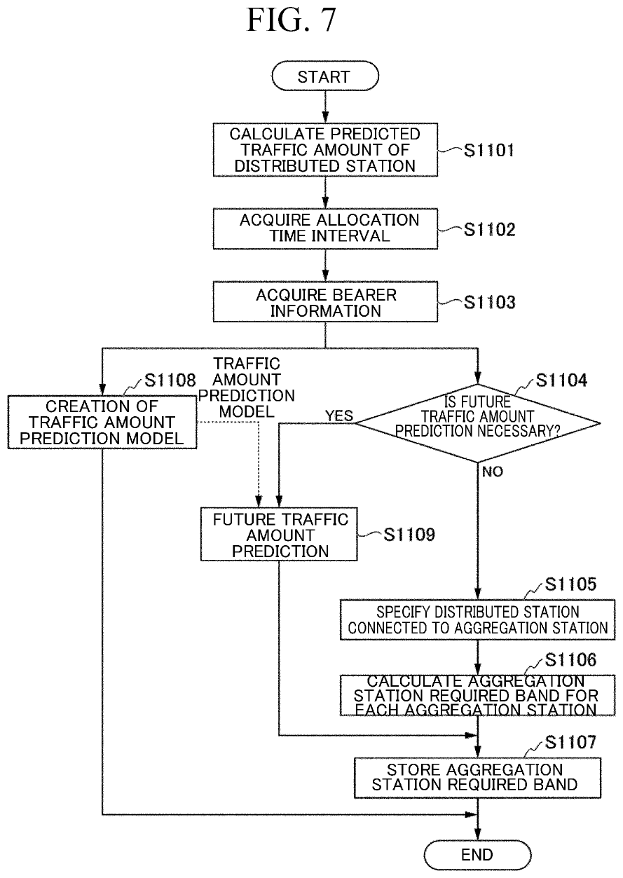

Next, an example of a processing procedure of the switching control apparatus 160 will be described with reference to FIGS. 7 to 11.

FIG. 7 is a flow diagram illustrating switching band control processing of the switching control apparatus 160. The controller 133 of the distributed station 130 notifies the terminal 11 of the DCI (i) in the next transmission period at time t(i−1), and further notifies the switching control apparatus 160 of the DCI information in which the DCI (i) has been set (i is an integer). The DCI (i) is DCI indicating radio resources allocated to the terminal 11 in the transmission period U(i) from the time t(i) to the time t(i+1), and an encoding rate and a modulation system used by the terminal 11.

The switching control apparatus 160 receives the DCI information in which the DCI (i) has been set, from the distributed station 130 at time t(i−1). The traffic amount calculator 161 calculates the predicted traffic amount DU(i) of the distributed station 130 in the transmission period U(i) in each distributed station 130 on the basis of information included in the DCI (i) (step S1101). Further, the traffic amount calculator 161 calculates the allocation time interval T(i) from a difference between the time t(i) and the time t(i+1) (step S1102). Alternatively, the traffic amount calculator 161 may receive the allocation time interval T(i) from the distributed station 130. The traffic amount calculator 161 stores the predicted traffic amount DU(i) and the allocation time interval T(i) of each distributed station 130 in the storage 167.

The required band calculator 163 receives the bearer information from the aggregation station 140 or the resource management apparatus 170 and stores the bearer information in the storage 167. The required band calculator 163 reads the bearer information from the storage 167 (step S1103). The traffic amount calculator 161 determines whether or not the prediction of the future traffic amount is necessary (step S1104). The future traffic amount is a predicted traffic amount in the transmission period U(i+1) from time t(i+1) to time t(i+2). In the mobile NW system 100, a time required from the instruction of path switching in the switching control apparatus 160 to the completion of the switching is defined as a switching time Tc (for example, 2 msec). When the switching time Tc is equal to or less than the allocation time interval T(i) (Tc≤T(i)), the path switching can be completed by the time t(i). Therefore, the traffic amount calculator 161 determines that the prediction of the future traffic amount is unnecessary (step S1104: No).

The required band calculator 163 specifies the distributed station 130 under the control of each aggregation station 140 on the basis of the bearer information (step S1105). The required band calculator 163 sums the predicted traffic amounts DU(i) of the respective distributed stations 130 under control for each aggregation station 140, to calculate the aggregation station required band CU(i) in the transmission period U(i) (step S1106). The required band calculator 163 stores the aggregation station required band CU(i) of each aggregation station 140 in the storage 167, and activates the determiner 164 (step S1107).

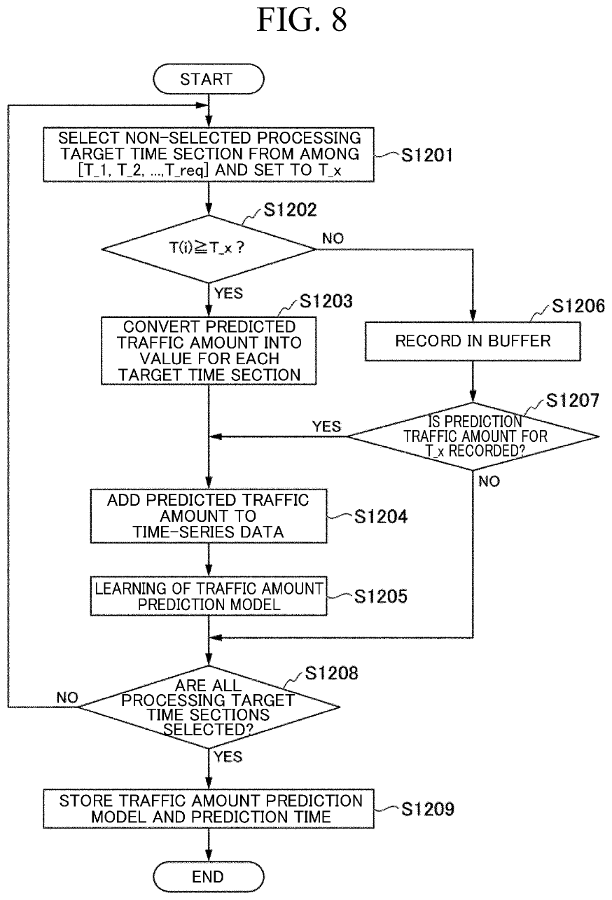

On the other hand, the future traffic amount predictor 162 creates the traffic amount prediction model in parallel with the processing of step S1104 (step S1108). The traffic amount prediction model is a model for predicting a traffic amount in a next transmission period of the input data by using the traffic amount in a time-series transmission period as the input data. Details of the creation of the traffic amount prediction model will be described below with reference to FIG. 8.

In step S1104, when the switching time Tc is longer than the allocation time interval T(i) (Tc>T(i)), the traffic amount calculator 161 determines that the prediction of the future traffic amount is necessary (step S1104: Yes). This is because it is predicted that the path switching cannot be completed by time t(i). The traffic amount calculator 161 instructs the future traffic amount predictor 162 to predict the future traffic amount.

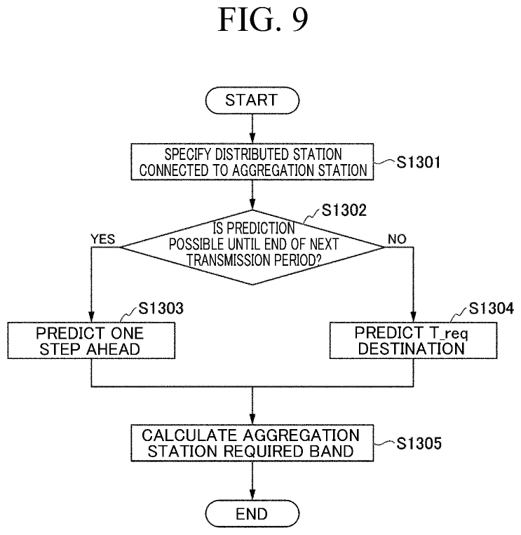

The future traffic amount predictor 162 predicts the future traffic amount DU(i+1) of each distributed station 130 in the transmission period U(i+1) from the time t(i+1) to a time t(i+2) by using the traffic amount prediction model created in step S1108 (step S1109). Details of the prediction processing will be described below with reference to FIG. 9.

The required band calculator 163 sums future traffic amounts DU(i+1) of the distributed stations 130 under control for each aggregation station 140 to calculate the aggregation station required band CU(i+1) in the transmission period U(i+1). The required band calculator 163 stores the aggregation station required band CU(i+1) of each aggregation station 140 in the storage 167, and activates the determiner 164 (step S1107).

FIG. 8 is a flow diagram illustrating traffic amount prediction model creation processing of the future traffic amount predictor 162. FIG. 8 illustrates detailed processing in step S1108 of FIG. 7.

The storage 167 stores the K time sections T_1, T_2, . . . , T_k-1, and T_req of a processing target in advance. The time sections T_1 to T_k-1 are TTI available when resource blocks are allocated to the terminal 11. For example, T_1 to T_k-1 are 125 us, 250 us, 500 us, and 1 ms. The allocation time interval T(i) is the same value as any of the time intervals T_1 to T_k-1. The time interval T_req is a value required by an application or the like. The time interval T_req is larger than T_1 to T_k-1. The future traffic amount predictor 162 may receive the value of the time interval T_req from another apparatus such as an apparatus connected to the terminal 11 or the upper NW, and store the value in the storage 167. The future traffic amount predictor 162 selects a non-selected time section from among the time sections T_1 to T_req, and sets the time section to T_x (step S1201).

The future traffic amount predictor 162 determines whether or not the allocation time interval T(i) is equal to or more than the time interval T_x (step S1202). When it is determined that the allocation time interval T(i) is equal to or longer than the time interval T_x (step S1202: Yes), the future traffic amount predictor 162 converts the predicted traffic amount DU(i) of the distributed station 130 into a predicted traffic amount for each time interval T_x (step S1203). That is, the future traffic amount predictor 162 calculates the occurrence of the predicted traffic amount DU_T_x of the predicted traffic amount DU(i)×(time interval T_x/allocation time interval T(i)) for each time interval T_x between time t(i) and time t(i+1).

For example, it is assumed that the allocation time interval T(i) is 250 us and the time interval T_x is 125 us. The future traffic amount predictor 162 predicts that a traffic amount of DU_125 us=DU(i)/2 occurs between time t(i) and time t(i)+125 us and between time t(i)+125 us and time t(i+1). Further, when the time section T_x is 250 us, the future traffic amount predictor 162 predicts that a traffic amount of DU_250 us=DU(i) occurs between time t(i) and time t(i+1).

The future traffic amount predictor 162 adds the predicted traffic amount calculated in step S1203 to the predicted traffic amount of time series calculated in the past for the time section T_x for each distributed station 130, and stores the result in the storage 167 (step S1204). The future traffic amount predictor 162 learns the traffic amount prediction model of the time section T_x by using the time-series prediction traffic amount of the distributed station 130 of the time section T_x stored in the storage 167 (step S1205).

For example, the time-series predicted traffic amount of the distributed station 130 in the time section T_x are DU_T_x (P), DU_T_x (P−1), DU_T_x (P−2), . . . , and DU_T_x (1) (P is an integer equal to or greater than 2) in order of newer time. The future traffic amount predictor 162 generates learning data with DU_T_x (p) as correct output data and DU_T_x (p−1) to DU_T_x (p-q) as input data while sequentially subtracting the value of p from P by one (q is an integer equal to or greater than 1) for each distributed station 130. The future traffic amount predictor 162 learns the traffic amount prediction model representing correspondence between input data and output data by using the generated learning data. The future traffic amount predictor 162 may learn one traffic amount prediction model using the learning data of all the distributed stations 130, or may learn the traffic amount prediction model of the distributed stations 130-m using the learning data of the distributed stations 130-m.

On the other hand, in step S1202, when it is determined that the allocation time interval T(i) is smaller than the time interval T_x (step S1202: No), the future traffic amount predictor 162 performs processing of step S1206. The future traffic amount predictor 162 records the predicted traffic amount DU(i) of the distributed station 130-m in a buffer corresponding to the distributed station 130-m and the time section T_x in the future traffic amount predictor 162 or the storage 167 (step S1206). The future traffic amount predictor 162 determines whether or not the predicted traffic amount for the time section T_x is recorded in a buffer corresponding to each distributed station 130 and the time section T_x (step S1207).

For example, it is assumed that the allocation time interval T(i) is 250 us and the time interval T_x is 500 us. The future traffic amount predictor 162 determines whether or not the predicted traffic amount of T_x/T(i)=2 is recorded in a buffer corresponding to 500 us. It is also assumed that the time interval T_x is 5 ms of T_req. The future traffic amount predictor 162 determines whether the predicted traffic amount of T_req/T(i)=5000/250=20 is recorded in a buffer corresponding to 5 ms. When the future traffic amount predictor 162 determines that the predicted traffic amount for the time section T_x is not recorded in the buffer corresponding to the time section T_x (step S1207: No), the future traffic amount predictor 162 performs processing from step S1208.

When the future traffic amount predictor 162 determines that the predicted traffic amount for the time section T_x is recorded in the buffer corresponding to the time section T_x for each distributed station 130 (step S1207: Yes), the future traffic amount predictor 162 performs processing of step S1204. That is, the future traffic amount predictor 162 reads the predicted traffic amount DU(i−T_x/T(i)+1) to the predicted traffic amount DU(i) from the buffer corresponding to the time interval T_x and sums the amounts to obtain DU_T_x (P) for each distributed station 130.

For example, it is assumed that the allocation time interval T(i) is 250 us and the time interval T_x is 500 us. The future traffic amount predictor 162 sums the predicted traffic amount DU(i−1) and the predicted traffic amount DU(i) to calculate DU_500 us (P). It is also assumed that the time interval T_x is 5 ms of T_req. The future traffic amount predictor 162 sums the predicted traffic amounts DU(i−19) to DU(i) to calculate DU_5 ms (P).

The storage 167 stores time-series predicted traffic amounts DU_T_x (1) to DU_T_x (P−1) of each distributed station 130 calculated in the past for the time section T_x. The future traffic amount predictor 162 adds a newly calculated predicted traffic amount DU_T_x (P) to the predicted traffic amounts DU_T_x (1) to DU_T_x (P−1) for each distributed station 130 and stores a result in the storage 167 (step S1204). The future traffic amount predictor 162 performs processing of step S1205, and learns the traffic amount prediction model by using a time-series prediction traffic amount of the time section TX.

After the processing of step S1205 or when the determination is no in step S1207, the future traffic amount predictor 162 determines whether all the K time sections T_1 to T_req of the processing target are selected (step S1208). When there is a non-selected time section (step S1208: No), the future traffic amount predictor 162 returns to step S1201 and sets a newly selected time section to T_x.

When it is determined that all the K time sections of the processing target are selected (step S1208: Yes), the future traffic amount predictor 162 stores the traffic amount prediction model corresponding to the K time sections T_1 to T_req and a prediction time which is a time from input of input data to the traffic amount prediction model to output of output data in the storage 167 (step S1209).

The future traffic amount predictor 162 may execute processing of steps S1202 to S1207 in parallel for the K time sections T_1 to T_req.

FIG. 9 is a flow diagram illustrating the future traffic amount prediction processing of the future traffic amount predictor 162. FIG. 9 illustrates detailed processing in step S1109 of FIG. 7. The future traffic amount predictor 162 specifies the distributed station 130 connected to each aggregation station 140 on the basis of the bearer information (step S1301). The future traffic amount predictor 162 determines whether or not the prediction of the future traffic amount is possible by time t(i+1) when the next the transmission period U(i) ends (step S1302). Specifically, the future traffic amount predictor 162 determines whether or not a sum of the allocation time interval T(i) and the switching time Tc is longer than the prediction time of the traffic amount prediction model at the allocation time interval T(i).

When the allocation time interval T(i)+ the switching time Tc is longer than the prediction time (T(i)+Tc>prediction time), the future traffic amount predictor 162 determines that the future traffic amount can be predicted until the end of the next the transmission period U(i) (step S1302: Yes). The future traffic amount predictor 162 inputs p time-series predicted traffic amounts DU (P) to DU (P−p+1) from the latest one of the allocation time intervals T(i) to the traffic amount prediction model created for the allocation time interval T(i) for each distributed station 130. The future traffic amount predictor 162 calculates the future traffic amount DU(i+1) of each distributed station 130 in the transmission period U(i+1) from time t(i+1) to time t(i+2) (step S1303). t(i+2)=t(i+1)+T(i). The future traffic amount predictor 162 writes the calculated future traffic amount DU(i+1) of each distributed station 130 to the storage 167.

When the prediction time is equal to or longer than the allocation time T(i)+ the switching time Tc (T(i)+Tc≤ the prediction time), the future traffic amount predictor 162 determines that the prediction of the future traffic amount is impossible until the end of the next the transmission period U(i) (step S1302: No). The future traffic amount predictor 162 performs the prediction from the time t(i+1) to a time section T_req (for example, 5 ms) satisfying the service request delay. The future traffic amount predictor 162 calculates a time-series predicted traffic amount of the time section T_req by summing the time-series predicted traffic amount of the allocation time interval T(i) by T_req/T(i) in order from the new one, for each distributed station 130. The future traffic amount predictor 162 inputs q time-series predicted traffic amounts from the latest one of the time sections T_req to the traffic amount prediction model created for the time section T_req, for each distributed station 130. Thus, the future traffic amount predictor 162 calculates the future traffic amount DUreq(i+1) of each distributed station 130 in the transmission period U(i+1) from the time t(i+1) to the time t(i+2) (step S1304). t(i+2)=t(i+1)+T_req. The future traffic amount predictor 162 writes the calculated future traffic amount DUreq(i+1) of each distributed station 130 to the storage 167.

The required band calculator 163 calculates the aggregation station required band CU(i+1) in the transmission period U(i+1) by summing the future traffic amount DU(i+1) calculated in step S1303 or the future traffic amount DUreq(i+1) calculated in step S1304 with respect to the distributed stations 130 under control for each aggregation station 140 (step S1305). In step S1107 of FIG. 7, the required band calculator 163 stores the aggregation station required band CU(i+1) of each aggregation station 140 in the storage 167.

When the predicted traffic amount of the distributed station 130 cannot be calculated, the traffic amount calculator 161 performs estimation through processing of any of the following (1) to (3).

(1) The traffic amount calculator 161 acquires DCI transmitted from the distributed station 130 to the aggregation station 140, and calculates a predicted traffic amount by using the acquired DCI instead of the DCI information received from the distributed station 130.

(2) When the predicted traffic amount of some of the distributed stations 130 under the control of the aggregation station 140 can be calculated, an average of the calculated predicted traffic amounts of the distributed stations 130 is set as the predicted traffic amount of the distributed stations 130 in which the predicted traffic amount cannot be calculated.

(3) The traffic amount calculator 161 inputs the predicted traffic calculated by (1) in the past to the traffic amount prediction model to estimate the predicted traffic amount.

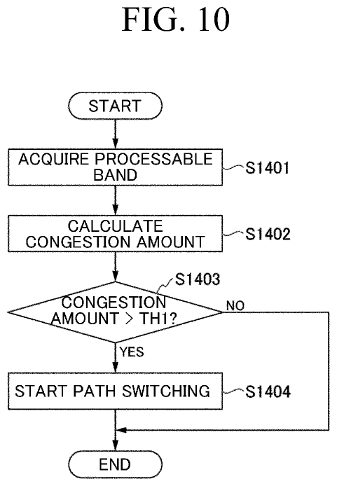

FIG. 10 is a flow diagram illustrating congestion determination processing of the determiner 164. The determiner 164 acquires a processable band of each aggregation station 140 (step S1401). When information on the maximum processable band of the aggregation station 140 is received in advance, the determiner 164 reads the maximum processable band from the storage 167 and sets the maximum processable band as a processable band X_resource. When the aggregation station resource information is received from the resource management apparatus 170 and stored in the storage 167, the determiner 164 reads information on the allocated resource of the aggregation station 140 from the aggregation station resource information. The allocated resource is the number of cores of the aggregation station 140, an occupancy rate of the cores, or a resource block in the frequency direction. When the number of cores of the CPU is larger, the occupancy of the CPU is higher, or when the number of resource blocks in the frequency direction is large, the processable band increases. The determiner 164 calculates a processable band X_resource of the aggregation station 140 from the read allocated resource amount on the basis of a relationship between the allocated resource amount and the processable band stored in advance.

The determiner 164 reads the information on the buffer amount X_buffer acquired from the aggregation station 140 and stored in the storage 167. Further, the determiner 164 reads the aggregation station required band CU(i) or CU(i+1) of the aggregation station 140 stored in the storage 167 in step S1107 of FIG. 7 by the required band calculator 163, and defines the band as a required band X_traffic. The determiner 164 calculates a congestion amount X_buf by using the following equation (1) for each aggregation station 140 (step S1402).

$$X\_buf = X\_traffic + X\_buffer - X\_resource \qquad ( 1 )$$

The determiner 164 may perform calculation of the congestion amount X_buf of each aggregation station 140 in parallel or may sequentially perform the calculation. The determiner 164 determines whether or not the congestion amount X_buf of any aggregation station 140 exceeds a threshold TH1 (step S1403).

For example, when it is determined that a state in which no data is accumulated in the buffer is no congestion, and sets TH1=0. Alternatively, the amount of congestion satisfying an allowable delay may be set to TH1. The amount of congestion x_tol_buf satisfying the allowable delay is calculated by the following equation (2).

$$X\_tol \_buf = X\_resource / T 1 \times T 2 \qquad ( 2 )$$

T1 is a time from the reception of the DCI information by the switching control apparatus 160 to the transmission of actual uplink traffic by the distributed station 130. The switching time Tc may be used as T1. T2 is an allowable congestion delay obtained by subtracting a transmission delay or a processing delay and a switching delay from the allowable delay.

When the congestion amount X_buf of all the switching control apparatuses 160 is equal to or smaller than the threshold TH1, the determiner 164 determines that congestion does not occur, and ends the processing (step S1403: No). That is, the switching control apparatus 160 does not execute the path switching. On the other hand, when the congestion amount X_buf of any switching control apparatus 160 exceeds the threshold TH1, the determiner 164 determines that congestion occurs (step S1403: Yes). The determiner 164 instructs the switching determiner 165 to start path switching processing (step S1404).

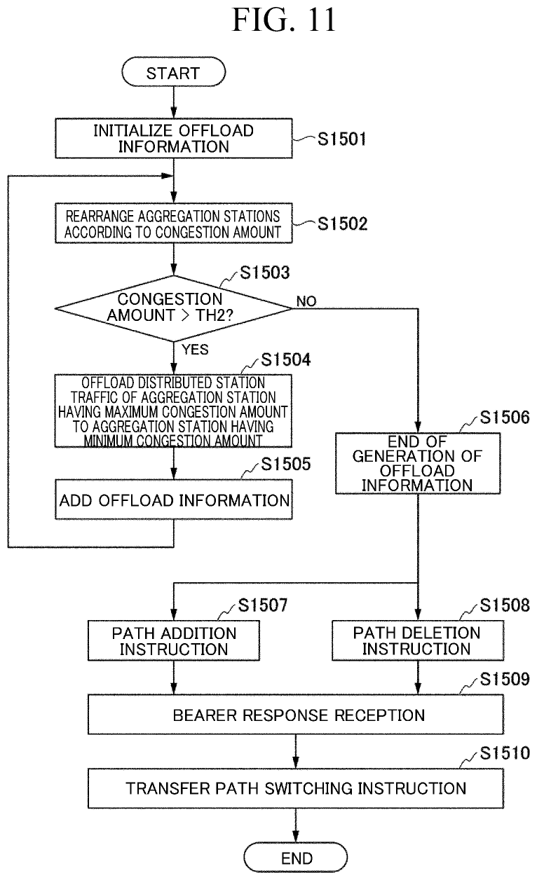

FIG. 11 is a flow diagram illustrating path switching control processing of the switching control apparatus 160. The switching determiner 165 starts the processing of FIG. 11 when the execution of the path switching is instructed from the determiner 164 in step S1404 of FIG. 10.

The switching determiner 165 initializes offload information stored in the storage 167 (step S1501). The switching determiner 165 generates load information in which the aggregation station 140 with the congestion amount of the aggregation station 140, the distribution station 130 under control, and the predicted traffic amount of the distribution station 130 under control. The switching determiner 165 arranges the load information in order of the congestion amount and writes the load information to the storage 167 (step S1502). The predicted traffic amount is the predicted traffic amount DU(i) used when the aggregation station required band CU(i) is calculated in step S1106, a predicted traffic amount DU(i+1) calculated in step S1303, or a predicted traffic amount DUreq(i) calculated in step S1304.

The switching determiner 165 determines whether there is load information in which a congestion amount exceeding a threshold TH2 has been set (step S1503). The threshold TH2 may be 0, and may be a positive value equal to or less than the congestion amount X_tol_buf used as the threshold TH1 in step S1403 of FIG. 10.

When it is determined that there is a congestion amount exceeding the threshold TH2 (step S1503: Yes), the switching determiner 165 executes processing of step S1504. That is, the switching determiner 165 refers to the load information to specify the aggregation station 140-n1 (n1 is an integer equal to or greater than 1 and equal to or smaller than N) having the largest congestion amount and the aggregation station 140-n2 (n2 is an integer equal to or greater than 1 and equal to or smaller than N; n1≠n2) having the smallest congestion amount. The switching determiner 165 selects the distributed station 130 having the largest predicted traffic as the distributed station 130 that is a switching target from among the distributed stations 130 under control of the aggregation stations 140-n1. The switching determiner 165 changes the distributed station 130 that is a switching target from under control of the aggregation station 140-n1 to under control of the aggregation station 140-n2 (step S1504).

The switching determiner 165 associates switching source aggregation station information indicating the aggregation station 140-n1, switching destination aggregation station information indicating the aggregation station 140-n2, and switching target distributed station information indicating the distributed station 130 that is a switching target with one another, and sets the information in offload information (step S1505). The switching determiner 165 repeats processing from step S1502. In step S1502, the switching determiner 165 deletes the predicted traffic amount of the distributed station 130 that is a switching target and the distributed station 130 that is a switching target from the load information of the aggregation station 140-n1. The switching determiner 165 updates the congestion degree set in the load information of the aggregation stations 140-n1 to a value obtained by subtracting the predicted traffic amount of the distributed station 130 that is a switching target. Further, the switching determiner 165 adds the predicted traffic amount of the distributed station 130 that is a switching target and the distributed station 130 that is a switching target to the load information of the aggregation station 140-n2. The switching determiner 165 updates the congestion degree set in the load information of the aggregation stations 140-n2 to a value obtained by adding the predicted traffic amount of the distributed station 130 that is a switching target. The switching determiner 165 rearranges the load information of each aggregation station 140 according to the congestion degree.

When it is determined that there is no congestion amount exceeding the threshold TH2 in any load information (step S1503: No), the switching determiner 165 ends generation of the offload information and instructs the switching instructor 166 to start switching (step S1506).

The switching instructor 166 reads the switching source aggregation station information, the switching destination aggregation station information, and the switching target distributed station information from the offload information. The switching instructor 166 transmits the path addition instruction for adding traffic of the distributed station 130 indicated by the switching target distributed station information to the aggregation station 140 indicated by the switching destination aggregation station information (step S1507, and step S1008 in FIG. 6). Further, the switching instructor 166 transmits path deletion instruction for deleting the traffic of the distributed station 130 indicated by the switching target distributed station information to the aggregation station 140 indicated by the switching source aggregation station information (step S1508, and step S1009 in FIG. 6). The switching instructor 166 receives a bearer response to the path addition instruction and a bearer response to the path deletion instruction (step S1509, and steps S1011 to S1012 in FIG. 6). The switching instructor 166 transmits an instruction to switch the transfer path to the transfer apparatus 150 (step S1510, and step S1017 in FIG. 6).

Although the determiner 164 uses the band for determination as to whether or not congestion occurs in the above description, a bit rate of the uplink signal output from the user data transmitter and receiver 141 of the aggregation station 140 may be used. The bit rate is calculated by the traffic amount/required band. The required band calculator 163 determines that congestion occurs when the bit rate exceeds 1, and determines that congestion does not occur when the bit rate is 1 or less.

Further, the switching control apparatus 160 may not determine whether or not the path switching can be completed by the next transmission period. In this case, the switching control apparatus 160 may not have the future traffic amount predictor 162. The switching control apparatus 160 does not execute the processing of steps S1104, S1108 and S1109 of FIG. 7 and the processing of FIGS. 8 and 9.

### Second Embodiment

In a second embodiment, the switching control apparatus acquires the required band from the aggregation station. The second embodiment will be described by focusing on a difference from the first embodiment.

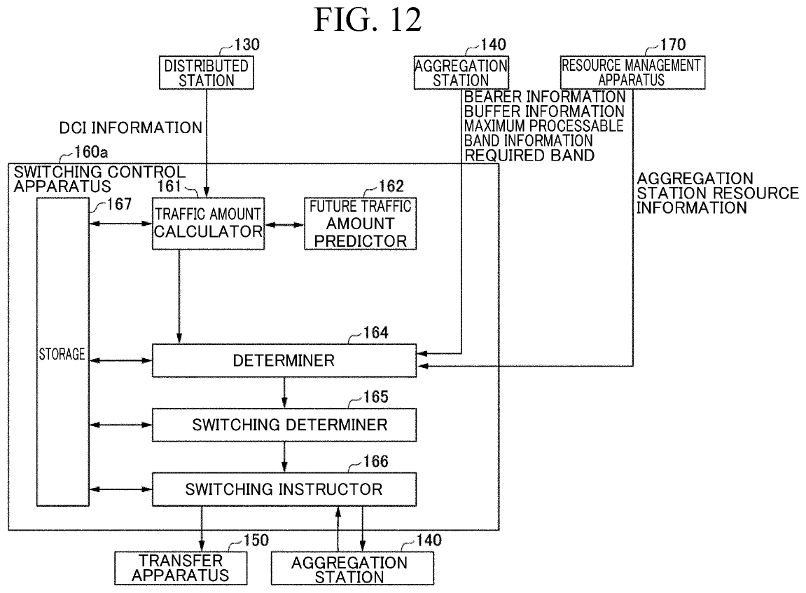

A configuration of the mobile NW system according to the second embodiment is the same as that of the mobile NW system 100 according to the first embodiment illustrated in FIG. 2. However, the mobile NW system 100 includes the switching control apparatus 160a illustrated in FIG. 12 in place of the switching control apparatus 160 illustrated in FIG. 5.

FIG. 12 is a block diagram illustrating a configuration example of the switching control apparatus 160a. The switching control apparatus 160a illustrated in FIG. 12 is different from the switching control apparatus 160 of the first embodiment illustrated in FIG. 5 in that the switching control apparatus 160a does not includes the required band calculator 163. The determiner 164 receives required band information indicating a required band from each aggregation station 140.

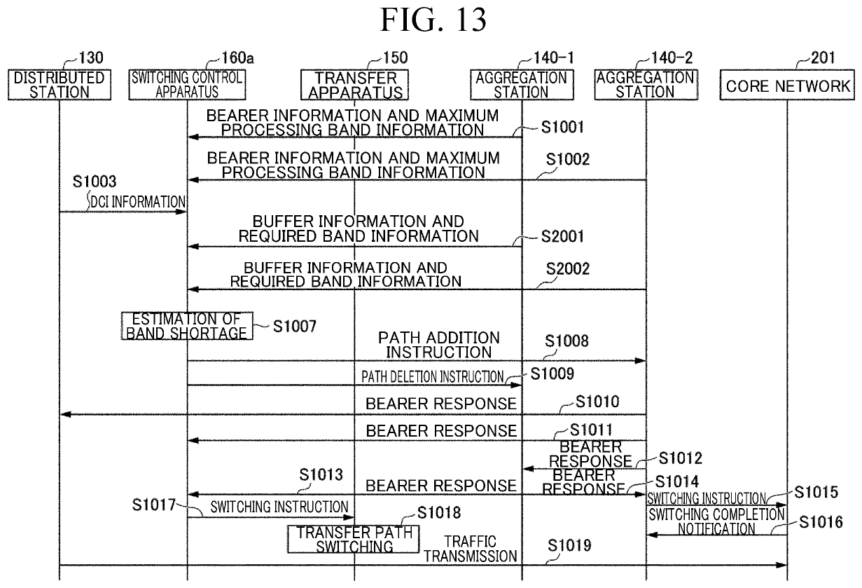

FIG. 13 is a sequence diagram illustrating a path switching procedure of the mobile NW system 100 of the present embodiment. The path switching procedure illustrated in FIG. 13 is different from the path switching procedure of the first embodiment illustrated in FIG. 6 in that the mobile NW system 100 performs the processing of steps S2001 and S2002 in place of the processing of steps S1004 to S1006. That is, each of the aggregation stations 140-1 and 140-2 transmits required band information indicating the required band of its own station to the switching control apparatus 160a in addition to the buffer information (step S2001 and step S2002).

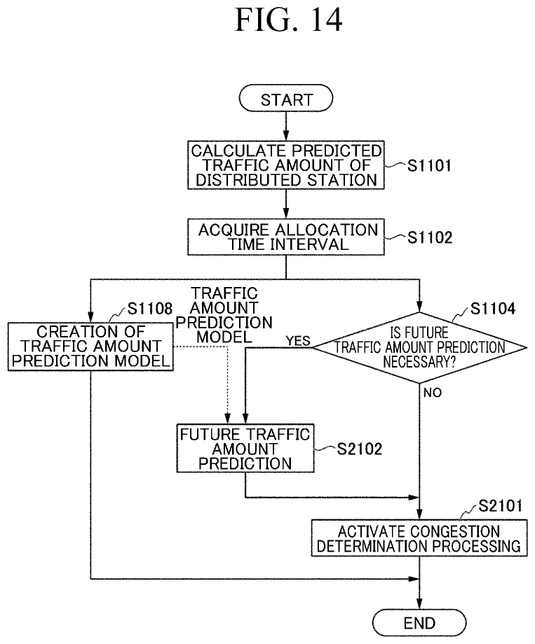

Next, processing of the switching control apparatus 160a will be described. FIG. 14 is a flow diagram illustrating switching band control processing of the switching control apparatus 160a. The switching control apparatus 160a performs processing illustrated in FIG. 14 instead of the processing illustrated in FIG. 7. In FIG. 14, the same units as the band control processing according to the first embodiment illustrated in FIG. 7 are denoted with the same reference signs, and description thereof are omitted.

The traffic amount calculator 161 of the switching control apparatus 160a performs the same processing as in steps S1101 to S1102 in FIG. 7 to obtain the predicted traffic amount DU(i) and the allocation time interval T(i) of each distributed station 130. The traffic amount calculator 161 stores the predicted traffic amount DU(i) and the allocation time interval T(i) in the storage 167. When it is determined that the prediction of the future traffic amount is unnecessary (step S1104: No), the traffic amount calculator 161 activates congestion determination processing of the determiner 164 (step S2101).

On the other hand, the future traffic amount predictor 162 creates the traffic amount prediction model in parallel with the processing of step S1104 (step S1108). When the traffic amount calculator 161 determines that the prediction of the future traffic amount is necessary (step S1104: Yes), the future traffic amount predictor 162 performs future traffic amount prediction processing (step S2102). In step S2102, the future traffic amount predictor 162 performs processing of steps S1301 to S1304 illustrated in FIG. 9.

After the processing of step S2102, the future traffic amount predictor 162 activates the congestion determination processing of the determiner 164 (step S2101). In this case, the predicted traffic amount of each distributed station 130 delivered to the determiner 164 is the future traffic amount DU(i+1) of each distributed station 130 calculated by the future traffic amount predictor 162 in step S1303 in FIG. 9 or the future traffic amount DUreq(i+1) of each distributed station 130 calculated in step S1304.

The determiner 164 of the switching control apparatus 160a performs the same processing as the congestion judging processing of the first embodiment illustrated in FIG. 10. However, in step S1402, the determiner 164 reads, as a required band X_traffic, an aggregation station required band indicated by the required band information received from each aggregation station 140 and stored in the storage 167. Since it is determined that the prediction of the future traffic amount is unnecessary in step S1104 of FIG. 14, the determiner 164 reads the aggregation station required band CU(i) in the transmission period U(i) when the future traffic amount predictor 162 does not perform processing illustrated in FIG. 9. On the other hand, when the future traffic amount predictor 162 performs the processing of step S1303 in FIG. 9, the determiner 164 reads the aggregation station required band CU(i+1) in the transmission period U(i+1) from the time t(i+1) to the time when the allocation time interval T(i) elapses, and when the future traffic amount predictor 162 performs the processing of step S1304 in FIG. 9, the determiner 164 reads the aggregation station required band CU(i+1) in the transmission period U(i+1) from the time t(i+1) to the time interval T_req.

The switching determiner 165 and the switching instructor 166 of the switching control apparatus 160a perform the same processing as the path switching instruction processing of the first embodiment illustrated in FIG. 11. In step S1502, the predicted traffic amount of the distributed station 130 written in the load information by the switching determiner 165 is the predicted traffic amount DU(i) when it is determined that the prediction of the future traffic amount is unnecessary in step S1104 of FIG. 14, and is the future traffic amount DU(i+1) or the future traffic amount DUreq(i+1) when it is determined that the prediction is necessary.

The switching control apparatus 160a may include the required band calculator 163 of the first embodiment. When some of the aggregation stations 140 cannot transmit the required band information, the switching control apparatus 160a calculates the required band of the aggregation station 140 as in the first embodiment.

When processing (steps S1008 to S1018 in FIG. 13) from estimation of band shortage to transfer path switching based on the required band information received in steps S2001 and S2002 in FIG. 13 and the predicted traffic amount of the distributed station 130 calculated by the traffic amount calculator 161 by using the DCI information received in step S1003 in FIG. 13 completes up to traffic transmission, the switching control apparatus 160a may not determine whether or not the path switching can be completed by the next transmission period. In this case, the switching control apparatus 160a does not have the future traffic amount predictor 162. The switching control apparatus 160a executes the processing of step S1104, step S1108, and step S2102 of FIG. 14.

When the switching control apparatus cannot calculate a part of the predicted traffic amount of the distributed station 130 connected to the aggregation station 140, it is not possible to ascertain the request band of the aggregation station 140 in the first embodiment. Therefore, in the present embodiment, the aggregation station 140 notifies the switching control apparatus 160a of the requested band. The switching determiner 165 of the switching control apparatus 160a selects a switching target from the distributed station 130 in which the predicted traffic amount or the future traffic amount is calculated when processing in step S1504 of FIG. 11 is performed.

### Third Embodiment

In the present embodiment, the switching control apparatus receives band information indicating a band of a current uplink signal from the distributed station 130 from an aggregation station. The switching control apparatus predicts a required band of the aggregation station by using the time-series band information. The third embodiment will be described by focusing on a difference from the first embodiment.

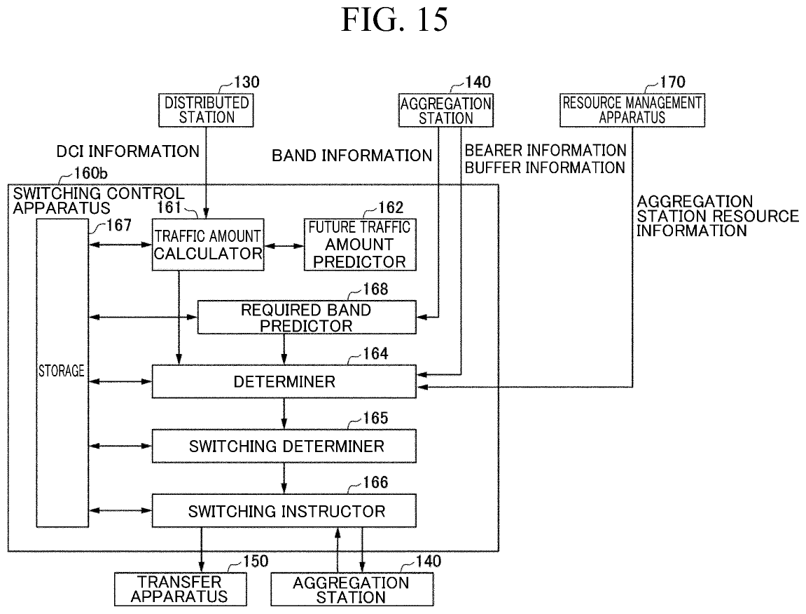

The configuration of the mobile NW system of the third embodiment is the same as that of the mobile NW system 100 of the first embodiment illustrated in FIG. 2. However, the mobile NW system 100 includes the switching control apparatus 160b illustrated in FIG. 15, in place of the switching control apparatus 160 illustrated in FIG. 5.

FIG. 15 is a block diagram illustrating a configuration example of the switching control apparatus 160b. The switching control apparatus 160b illustrated in FIG. 15 is different from the switching control apparatus 160 of the first embodiment illustrated in FIG. 5 in that a required band predictor 168 is provided in place of the required band calculator 163. The required band predictor 168 receives band information from each aggregation station 140. The band information indicates a current allocation time interval and a band of uplink traffic at the current allocation time interval. The allocation time interval is represented by, for example, a slot, but may be represented by a start time and an end time. The required band predictor 168 predicts the required band of each aggregation station 140 by using the band information.

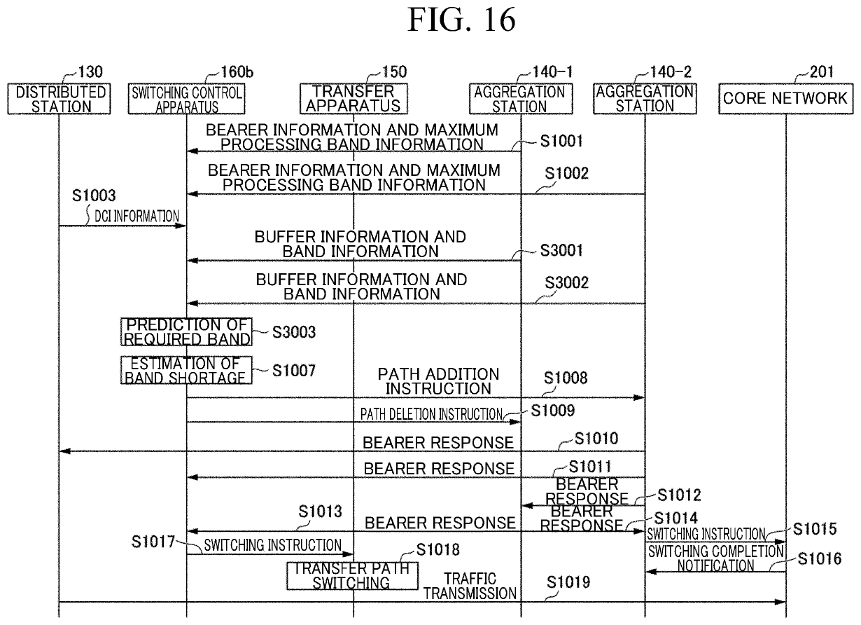

FIG. 16 is a sequence diagram illustrating a path switching procedure of the mobile NW system 100 of the present embodiment. The path switching procedure illustrated in FIG. 16 is different from the path switching procedure of the first embodiment illustrated in FIG. 6 in that the mobile NW system 100 performs processing of steps S3001 to S3003 in place of processing of steps S1004 to S1006. That is, the controller 143 of the aggregation stations 140-1 and 140-2 transmits the band information of the own station to the switching control apparatus 160b in addition to the buffer information for each time interval of resources allocation to the terminal 11 (step S3001 and step S3002). The band information indicates a current allocation time interval and a band of uplink traffic of the own station at the allocation time interval. The switching control apparatus 160b predicts the required band of the aggregation station 140-1 on the basis of the band information received from the aggregation station 140-1, and predicts the required band of the aggregation station 140-2 on the basis of the band information received from the aggregation station 140-2 (step S3003).

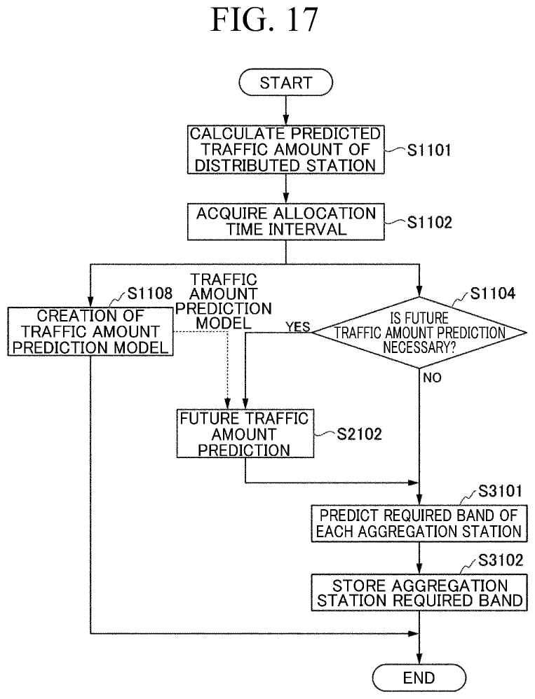

Next, processing of the switching control apparatus 160b will be described. FIG. 17 is a flow diagram illustrating band control processing of the switching control apparatus 160b. The switching control apparatus 160b performs the processing illustrated in FIG. 17 in place of the processing illustrated in FIG. 7. In FIG. 17, the same parts as the band control processing according to the first embodiment illustrated in FIG. 7 are denoted with the same reference signs, and descriptions thereof will be omitted.

The traffic amount calculator 161 of the switching control apparatus 160b performs the same processing as steps S1101 to S1102 in FIG. 7 to obtain the predicted traffic amount DU(i) and the allocation time interval T(i) of each distributed station 130. The traffic amount calculator 161 stores the predicted traffic amount DU(i) and the allocation time interval T(i) in the storage 167.

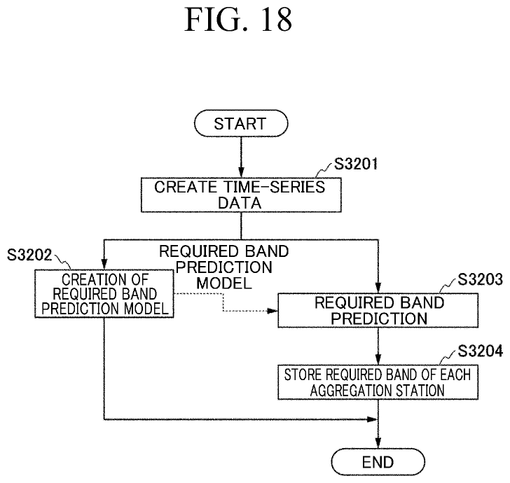

When it is determined that the prediction of the future traffic amount is unnecessary (step S1104: No), the traffic amount calculator 161 instructs the required band predictor 168 to predict the required band. The required band predictor 168 performs processing illustrated in FIG. 18 to be described below to predict a required band at the allocation time interval T(i) of each aggregation station 140 (step S3101). The required band predictor 168 stores a required band for prediction of each aggregation station 140 in the storage 167, and activates the determiner 164 (step S3102).

On the other hand, the future traffic amount predictor 162 creates the traffic amount prediction model in parallel with the processing of step S1104 (step S1108). When the traffic amount calculator 161 determines that the prediction of the future traffic amount is necessary (step S1104: Yes), the future traffic amount predictor 162 performs future traffic amount prediction processing (step S2101). The future traffic amount predictor 162 performs processing of steps S1301 to S1304 illustrated in FIG. 9 in step S2101.

The required band predictor 168 receives an instruction from the future traffic amount predictor 162, and predicts the required band of each aggregation station 140 in the transmission period U(i+1) from t(i+1) to the lapse of the allocation time interval T(i) or in the transmission period U(i+1) from t(i+1) to the lapse of the time interval T_req (step S3101). The required band predictor 168 stores the required band for prediction of each aggregation station 140 in the storage 167, and activates the determiner 164 (step S3102).

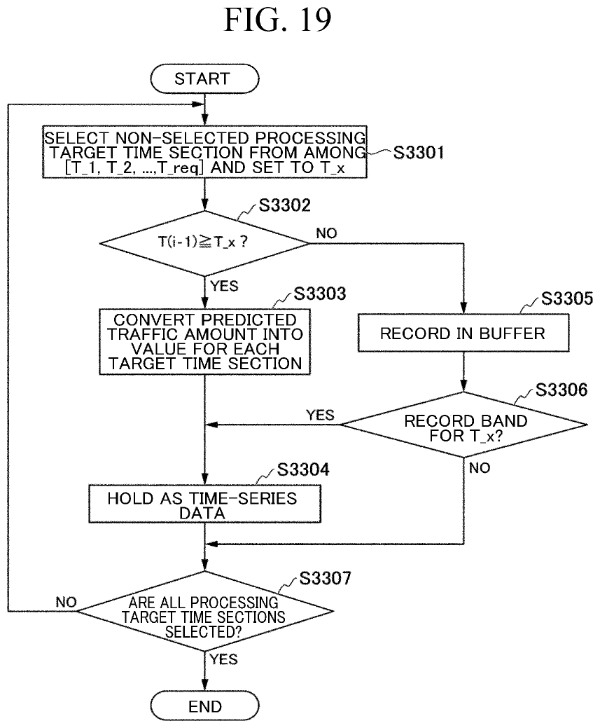

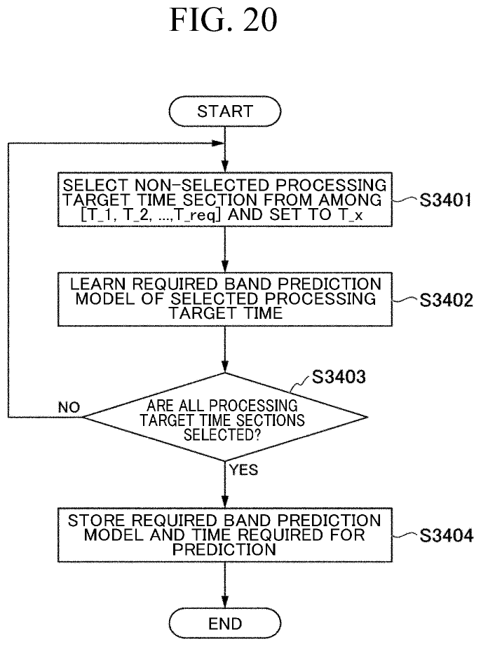

FIG. 18 is a flow diagram illustrating required band prediction processing of the required band predictor 168. FIG. 18 is a flow diagram illustrating detailed processing in S3101 in FIG. 17. The required band predictor 168 creates time-series data indicating a band of time-series uplink traffic of each aggregation station 140 (step S3201). Details of the creation of the time series data will be described below with reference to FIG. 19. The required band predictor 168 creates the required band prediction model by using the time series data (step S3202). The creation of the required band prediction model will be described below with reference to FIG. 20. The required band predictor 168 predicts the required band of each aggregation station 140 by using the required band prediction model generated in step S3202 (step S3203). The required band predictor 168 stores the required band for prediction of each aggregation station 140 in the storage 167, and activates the determiner 164 (step S3204).

FIG. 19 is a flow diagram illustrating time-series data generation processing of the required band predictor 168. FIG. 19 illustrates the processing of step S3201 in FIG. 18. The required band predictor 168 performs the processing illustrated in FIG. 19 for each aggregation station 140. The required band predictor 168 receives band information from the aggregation station 140 and writes the band information to the storage 167.

The required band predictor 168 selects a non-selected time section from among K time sections T_1, T_2, . . . , T_k-1, and T_req stored in the storage 167 and sets the time section to T_x (step S3301). The required band predictor 168 reads the newly received band information from the storage 167. The required band predictor 168 reads an allocation time interval T(i−1) and a band B(i−1) from the read band information. The band B(i−1) is a band of uplink traffic from time t(i−1) to time t(i). The allocation time interval T(i−1)=time t(i)−time t(i−1). The required band predictor 168 determines whether the allocation time interval T(i−1) is equal to or less than the time interval T_x (step S3302).

When it is determined that the allocation time interval T(i−1) is equal to or less than the time interval T_x, the required band predictor 168 converts the band B(i−1) into a band for each time interval T_x (step S3303). That is, the required band predictor 168 calculates a band for each time section T_x as a band B(i−1)×(time section T_x/allocation time interval T(i−1)).

For example, it is assumed that the allocation time interval T(i−1) is 250 us and the time interval T_x is 125 us. The required band predictor 168 calculates bands between the time t(i−1) and the time t(i−1)+125 us and between the time t(i−1)+125 us and the time t(i) as bands B (i−1)/2. When the time section T_x is 250 us, the required band predictor 168 sets a band between the time t(i−1) and the time t(i) as a band B(i−1).

The required band predictor 168 adds the band calculated in step S3303 to the time-series band acquired in the past for the time section T_x, and stores the resultant band in the storage 167 (step S3304).

On the other hand, in step S3302, when it is determined that the allocation time interval T(i−1) is smaller than the time interval T_x, the required band predictor 168 records the band B(i−1) in a buffer in the required band predictor 168 or the storage 167 (step S3305). The required band predictor 168 determines whether a band for the time section T_x is recorded in the buffer corresponding to the time section T_x (step S3306).

For example, it is assumed that the measurement time T(i−1) is 250 us and the time interval T_x is 500 us. The required band predictor 168 determines whether or not measurement bands for T_x/T(i−1)=2 are recorded in a buffer corresponding to 250 us. It is also assumed that the time interval T_x is 5 ms of T_req. The required band predictor 168 determines whether or not measurement bands for T_req/T(i−1)=5000/250=20 are recorded in a buffer corresponding to 5 ms. When it is determined that the band for the time section T_x is not recorded in the buffer corresponding to the time section T_x (step S3306: No), the required band predictor 168 performs processing of step S3307.

When it is determined that the predicted traffic amount for the time section T_x is recorded in a buffer corresponding to T_x (step S3306: Yes), the required band predictor 168 performs processing of step S3304. That is, the required band predictor 168 reads (T_x/T(i−1)) bands from the buffer corresponding to T_x and sums the bands. The required band predictor 168 adds the calculated total band to the time-series band acquired in the past for the time section T_x, and stores the resultant band in the storage 167.

After the processing of step S3304 or when the determination is no in step S3306, the required band predictor 168 determines whether all the K time sections of the processing target are selected (step S3307). When there is a non-selected time section (step S3307: No), the required band predictor 168 returns to step S3301 and sets a newly selected time section to T_x. When it is determined that all the K time sections of the processing target have been selected (step S3307: Yes), the required band predictor 168 ends the processing of FIG. 19.

The required band predictor 168 may execute processing of steps S3302 to S3306 in parallel for each of the K time sections T_1 to T_req.

FIG. 20 is a flow diagram illustrating the required band prediction model generation processing of the required band predictor 168. FIG. 20 illustrates processing of step S3202 in FIG. 18.

The required band predictor 168 selects a non-selected time section from among K time sections T_1, T_2, . . . , T_k-1, and T_req stored in the storage 167 and sets the time section to T_x (step S3401). The required band predictor 168 preferentially selects a time section matching the allocation time interval T(i) and T_req.

The required band predictor 168 learns the required band prediction model by using the time-series band of T_x stored in the storage 167 (step S3402). For example, the time-series bands at the time interval T_x are B_T_x (P), B_T_x (P−1), B_T_x (P−2), . . . , B_T_x (1) (P is an integer equal to or greater than 2) in order of newer time. The required band predictor 168 generates learning data in which B_T_x (p) is correct output data and B_T_x (p−1) to B_T_x (p-q) are input data while subtracting the value of p one by one in order from P (q is an integer equal to or greater than 1). The required band predictor 168 learns the required band prediction model representing correspondence between input data and output data by using these learning pieces of data. The required band predictor 168 may learn one required band prediction model by using the learning data of all the aggregation stations 140, or may learn the required band prediction model of the aggregation station 140-n by using the learning data of the aggregation station 140-n.

The required band predictor 168 determines whether all the K time sections of the processing target are selected (step S3403). When there is a non-selected time section (step S3403: No), the required band predictor 168 returns to step S3401 and sets a newly selected time section to T_x. When it is determined that all the K time sections of the processing target have been selected (step S3403: Yes), the required band predictor 168 stores, in the storage 167, the required band prediction model corresponding to each of K the time sections and a prediction time that is a time from input of input data to the required band prediction model to output of output data (step S3404).

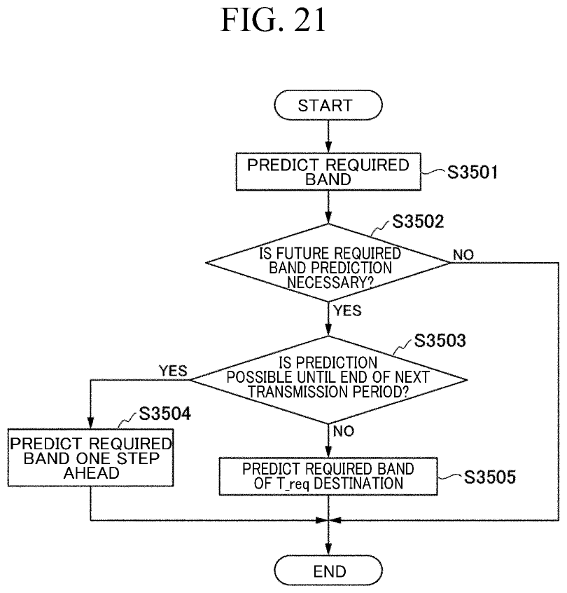

FIG. 21 is a flow diagram illustrating the required band prediction processing of the required band predictor 168. FIG. 20 illustrates detailed processing of step S3203 in FIG. 18. The required band predictor 168 predicts a required band of each distributed station 130 in the transmission period U(i) between time t(i) and time t(i+1) by using the required band prediction model generated in the required band prediction model generation processing of FIG. 20 (step S3501). Specifically, the required band predictor 168 inputs p time-series bands B_T_x (P) to B_T_x (P−p+1) from the latest one of the allocation time intervals T(i) to the required band prediction model created for the allocation time interval T(i) for each aggregation station 140. B_T_x (P) is a band of the aggregation station 140 in a transmission period U(i−1) from time t(i)−T(i) to time t(i). Thus, the required band predictor 168 calculates a required band B_T_x (P+1) of the aggregation station 140 in the next transmission period U(i) from the time t(i) to the time t(i+1).

The required band predictor 168 determines whether or not prediction of the future required band is necessary (step S3502). The future required band is a required band after time t(i+1). The required band predictor 168 determines that the prediction of the future required band is not necessary when the switching time Tc (for example, 2 msec) is equal to or less than the allocation time interval T(i) (Tc<T(i)) and ends the processing of FIG. 21 (step S3502: NO).

When the switching time Tc is longer than the allocation time interval T(i) (Tc>T(i)), the required band predictor 168 determines that the prediction of the future required band is necessary (step S3502: Yes). The required band predictor 168 determines whether or not the prediction of the future required band is possible by the time t(i+1) when the next the transmission period U(i) ends (step S3503). Specifically, the required band predictor 168 determines whether or not a sum of the allocation time interval T(i) and the switching time Tc is longer than the prediction time of the required band prediction model of the allocation time interval T(i).

When the allocation time interval T(i)+ the switching time Tc is longer than the prediction time (T(i)+Tc>prediction time), the required band predictor 168 determines that the required band can be predicted until the end of the next the transmission period U(i) (step S3503: Yes). The required band predictor 168 inputs p time-series bands B_T_x (P+1) to B_T_x (P−p+2) to the required band prediction model created for the allocation time interval T(i) for each aggregation station 140. Thus, the required band predictor 168 calculates the future required band of the aggregation station 140 in the transmission period U(i+1) from the time t(i+1) to the time t(i+2) (step S3504). B_T_x (P+1) is a band of the aggregation station 140 calculated in step S3501. The required band predictor 168 stores the future required band calculated in step S3504 in the storage 167 as the required band for prediction of the aggregation station 140 in step S3102 of FIG. 17.

When the prediction time is equal to or longer than the allocation time T(i)+ the switching time Tc (T(i)+Tc≤ the prediction time), the required band predictor 168 determines that prediction of the required band is impossible until the end of the next the transmission period U(i) (step S3503: No).

The required band predictor 168 performs prediction from the time t(i+1) to a time section T_req (for example, 5 ms) satisfying a service request delay. The required band predictor 168 sums, for each aggregation station 140, time-series bands B_T_x (P+1), B_T_x (P), B_T_x (P−1), . . . of the allocation time interval T(i) by T_req/T(i) in order from the new one to calculate a time-series band of the time section T_req. The required band predictor 168 inputs q time-series bands from the latest one of the time sections T_req to the required band prediction model created for the time sections T_req. Thus, the required band predictor 168 calculates the future required band of each aggregation station 140 in the transmission period U(i+1) from time t(i+1) to time t(i+2) (step S3505). t(i+2)=t(i+1)+T_req. The required band predictor 168 stores the future required band calculated in step S3505 in the storage 167 as a required band for prediction of the aggregation station 140 in step S3102 of FIG. 17.

### Fourth Embodiment

A mobile NW system 100 of a fourth embodiment transmits information to be transmitted from the distributed station 130 to the switching control apparatus 160 and information to be transmitted from the aggregation station 140 to the switching control apparatus 160, to the switching control apparatus 160 via the transfer apparatus 150. The fourth embodiment will be described by focusing on a difference from the first to third embodiments described above. A configuration of the mobile NW system of the fourth embodiment is the same as that of the mobile NW system 100 of the first embodiment illustrated in FIG. 2.

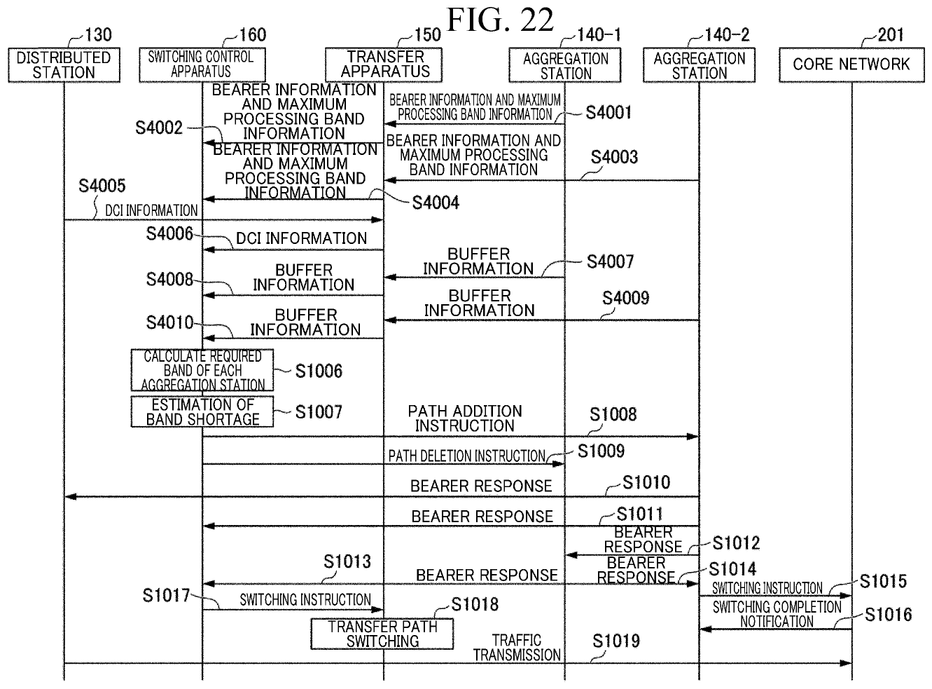

FIG. 22 is a sequence diagram illustrating a path switching procedure of the mobile NW system 100 of the fourth embodiment. The path switching procedure illustrated in FIG. 21 is different from the path switching procedure of the first embodiment illustrated in FIG. 6 in that the mobile NW system 100 performs processing of steps S4001 to S4010 in place of processing of steps S1001 to S1005.

That is, the controller 143 of the aggregation station 140-1 transmits the optical signal in which the bearer information and the maximum processable band information have been set to the transfer apparatus 150 (step S4001). The transfer apparatus 150 receives the optical signal in which the bearer information and the maximum processable band information have been set from the aggregation station 140-1, and outputs the received optical signal to the switching control apparatus 160 (step S4002). Similarly, the controller 143 of the aggregation station 140-2 transmits an optical signal in which bearer information and maximum processable band information have been set to the transfer apparatus 150 (step S4003). The transfer apparatus 150 receives the optical signal in which the bearer information and the maximum processable band information have been set from the aggregation station 140-2, and transmits the received optical signal to the switching control apparatus 160 (step S4004).

Each distributed station 130 transmits the optical signal in which the DCI information has been set to the transfer apparatus 150 (step S4005). The transfer apparatus 150 receives the optical signal in which the DCI information has been set from the distributed station 130, and transmits the received optical signal to the switching control apparatus 160 (step S4006). The controller 143 of the aggregation station 140-1 transmits the optical signal in which the buffer information has been set to the transfer apparatus 150 (step S4007). The transfer apparatus 150 receives the optical signal in which the buffer information has been set from the aggregation station 140-1, and transmits the received optical signal to the switching control apparatus 160 (step S4008). Similarly, the controller 143 of the aggregation station 140-2 transmits the optical signal in which the buffer information has been set to the transfer apparatus 150 (step S4009). The transfer apparatus 150 receives the optical signal in which the buffer information has been set from the aggregation station 140-2, and transmits the received optical signal to the switching control apparatus 160 (step S4010).

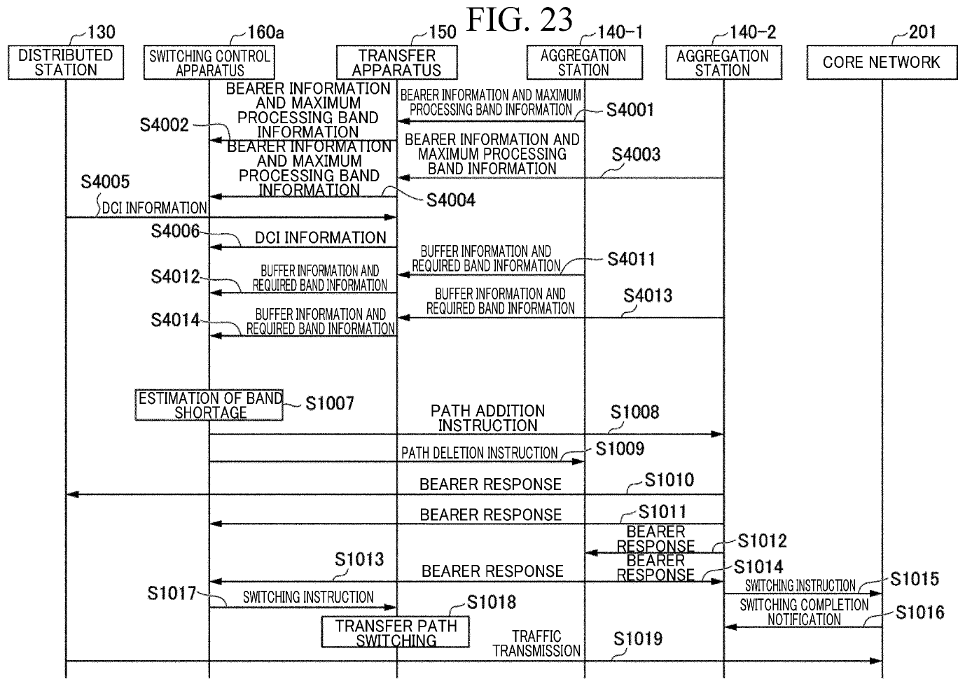

FIG. 23 is a sequence diagram illustrating a path switching procedure when the mobile NW system 100 includes the switching control apparatus 160a of a required band execution embodiment. The mobile NW system 100 performs the following processing in place of the processing of steps S4007 to S1006 illustrated in FIG. 22. That is, the aggregation station 140-1 transmits an optical signal in which the buffer information and the required band information have been set, to the transfer apparatus 150 (step S4011). The transfer apparatus 150 receives the optical signal in which the buffer information and the required band information have been set, from the aggregation station 140-1, and transmits the received optical signal to the switching control apparatus 160a (step S4012). Similarly, the aggregation station 140-2 transmits the optical signal in which the buffer information and the required band information have been set, to the transfer apparatus 150 (step S4013). The transfer apparatus 150 receives the optical signal in which the buffer information and the required band information have been set, from the aggregation station 140-2, and transmits the received optical signal to the switching control apparatus 160a (step S4014).

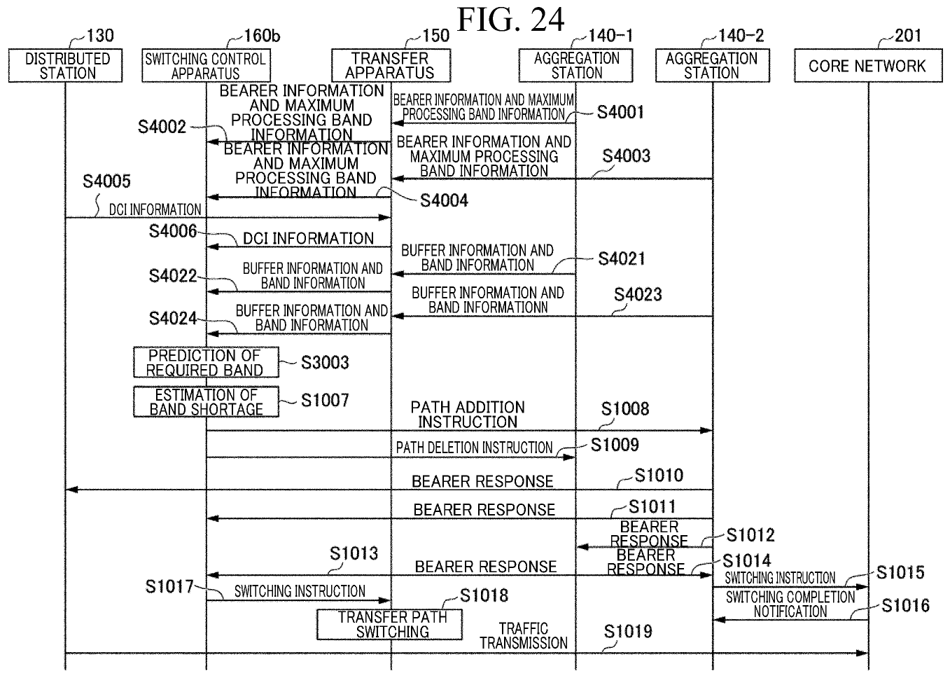

FIG. 24 is a sequence diagram illustrating a path switching procedure when the mobile NW system 100 includes the switching control apparatus 160b of the third embodiment. The mobile NW system 100 performs the following processing in place of the processing of steps S4007 to S1006 in FIG. 22. That is, the aggregation station 140-1 transmits an optical signal in which the buffer information and the band information have been set to the transfer apparatus 150 (step S4021). The transfer apparatus 150 receives the optical signal in which the buffer information and the band information have been set, from the aggregation station 140-1, and transmits the received optical signal to the switching control apparatus 160b (step S4022). Similarly, the aggregation station 140-2 transmits the optical signal in which the buffer information and the band information have been set, to the transfer apparatus 150 (step S4023). The transfer apparatus 150 receives the optical signal in which the buffer information and the band information have been set, from the aggregation station 140-2, and transmits the received optical signal to the switching control apparatus 160b (step S4024). The switching control apparatus 160b performs processing of step S3003 in FIG. 16 to predict the required band of each aggregation station 140.

### Fifth Embodiment

In a fifth embodiment, the radio control information acquisition apparatus acquires information transmitted from each of the distributed station and the aggregation station to the switching control apparatus in the above-described embodiment. The present embodiment will be described by focusing on a difference from the above-described embodiment.

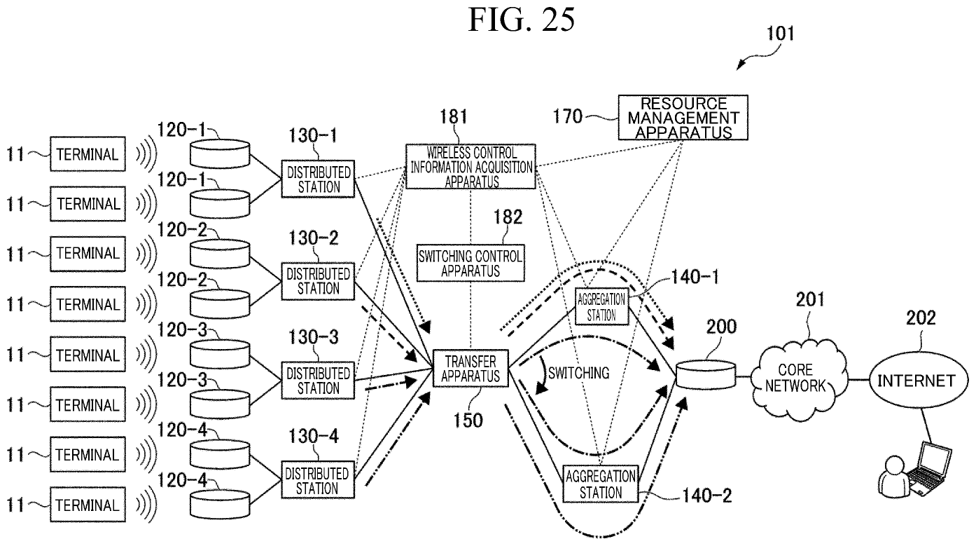

FIG. 25 is a diagram illustrating a configuration example of the mobile NW system 101 according to the present embodiment. The mobile NW system 101 illustrated in FIG. 25 is different from the mobile NW system 100 of the first embodiment illustrated in FIG. 2 in that the radio control information acquisition apparatus 181 and a switching control apparatus 182 are included in place of the switching control apparatus 160.

The mobile NW system 101 operates like the mobile NW system 100 of the first embodiment illustrated in FIG. 6 except that the following processing is performed in place of the processing of steps S1001 to S1005. That is, each distributed station 130 transmits the DCI information to the radio control information acquisition apparatus 181. Further, each aggregation station 140 transmits the bearer information, maximum processable band information, and the buffer information to the radio control information acquisition apparatus 181. Further, the resource management apparatus 170 transmits the aggregated station resource information to the radio control information acquisition apparatus 181. The radio control information acquisition apparatus 181 aggregates the DCI information received from each distributed station 130, the bearer information, maximum processable band information, and the buffer information received from each aggregation station 140, and the aggregated station resource information received from the resource management apparatus 170, and notifies the switching control apparatus 182 of a result of the aggregation. The switching control apparatus 182 performs the same processing as the switching control apparatus 160 of the first embodiment by using the information received from the radio control information acquisition apparatus 181.

Alternatively, the mobile NW system 101 operates like the mobile NW system 100 of the second embodiment illustrated in FIG. 13 except that the following processing is performed in place of the processing of steps S1001 to S2002. That is, each distributed station 130 transmits the DCI information to the radio control information acquisition apparatus 181. Each aggregation station 140 transmits bearer information, maximum processable band information, buffer information, and required band information to the radio control information acquisition apparatus 181. The resource management apparatus 170 transmits the aggregated station resource information to the radio control information acquisition apparatus 181. The radio control information acquisition apparatus 181 aggregates the DCI information received from each distributed station 130, the bearer information, the maximum processable band information, the buffer information, and the required band information received from each aggregation station 140, and the aggregation station resource information received from the resource management apparatus 170, and notifies the switching control apparatus 182 of a result of the aggregation. The switching control apparatus 182 performs the same processing as the switching control apparatus 160a of the second embodiment by using the information received from the radio control information acquisition apparatus 181.

Alternatively, the mobile NW system 101 operates like the mobile NW system 100 of the third embodiment illustrated in FIG. 16 except that the following processing is performed in place of the processing of steps S1001 to S2002. That is, each distributed station 130 transmits the DCI information to the radio control information acquisition apparatus 181. Each aggregation station 140 transmits bearer information, maximum processable band information, buffer information, and band information to the radio control information acquisition apparatus 181. The resource management apparatus 170 transmits the aggregated station resource information to the radio control information acquisition apparatus 181. The radio control information acquisition apparatus 181 aggregates the DCI information received from each distributed station 130, the bearer information, maximum processable band information, buffer information, and band information received from each aggregation station 140, and the aggregation station resource information received from the resource management apparatus 170, and notifies the switching control apparatus 182 of a result of the aggregation. The switching control apparatus 182 performs the same processing as the switching control apparatus 160b of the third embodiment by using the information received from the radio control information acquisition apparatus 181.

### Sixth Embodiment

In a sixth embodiment, an integrated control apparatus controls a plurality of switching control apparatuses. The present embodiment will be described by focusing on a difference from the above-described embodiment.

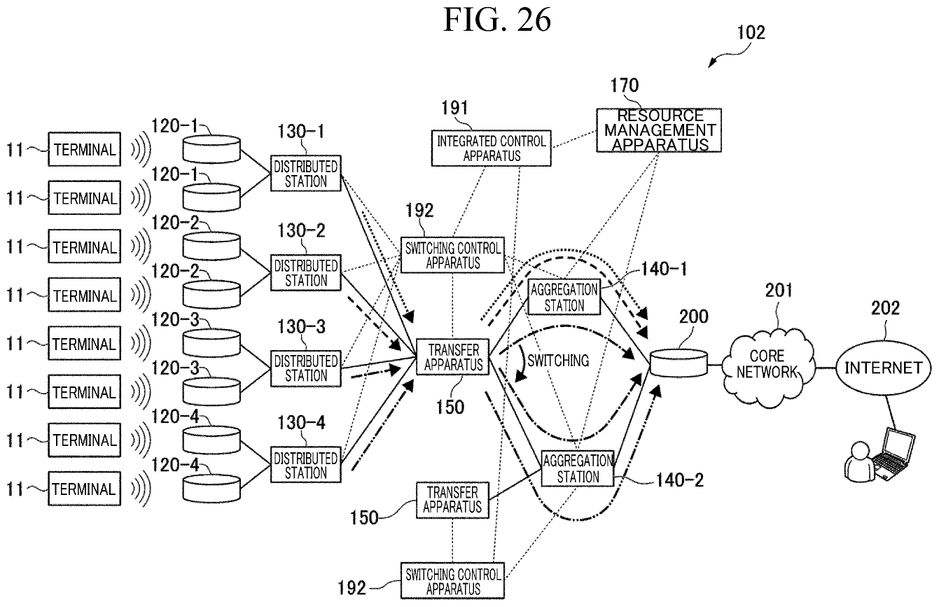

FIG. 26 is a diagram illustrating a configuration example of the mobile NW system 102 according to the present embodiment. The mobile NW system 102 illustrated in FIG. 26 is different from the mobile NW system 100 of the first embodiment illustrated in FIG. 2 in that an integrated control apparatus 191 and a switching control apparatus 192 are included in place of the switching control apparatus 160. The integrated control apparatus 191 is connected to one or more switching control apparatuses 192. The integrated control apparatus 191 has the same functions as those of the switching control apparatus 160, 160a, or 160b described above except for the function of the switching instructor 166.

The distributed station 130, the aggregation station 140, and the resource management apparatus 170 notify the integrated control apparatus 191 of various types of information of which the switching control apparatus 160, 160a, or 160b in the above-described embodiment is notified. The integrated control apparatus 191 performs the same processing as the switching control apparatus 160, 160a, or 160b except for the processing executed by the switching instructor 166 for each switching control apparatus 192. The integrated control apparatus 191 notifies the switching control apparatus 192 of the offload information generated as in the switching determiner 165. The switching control apparatus 192 performs the same processing as the switching instructor 166 by using the offload information received from the integrated control apparatus 191.

### Seventh Embodiment

In the above-described embodiment, the transfer apparatus and the switching control apparatus are provided in the midhole (MH) of the mobile NW system. In a seventh embodiment, a transfer apparatus and a switching control apparatus are provided in a front hole (FH) of the mobile NW system.

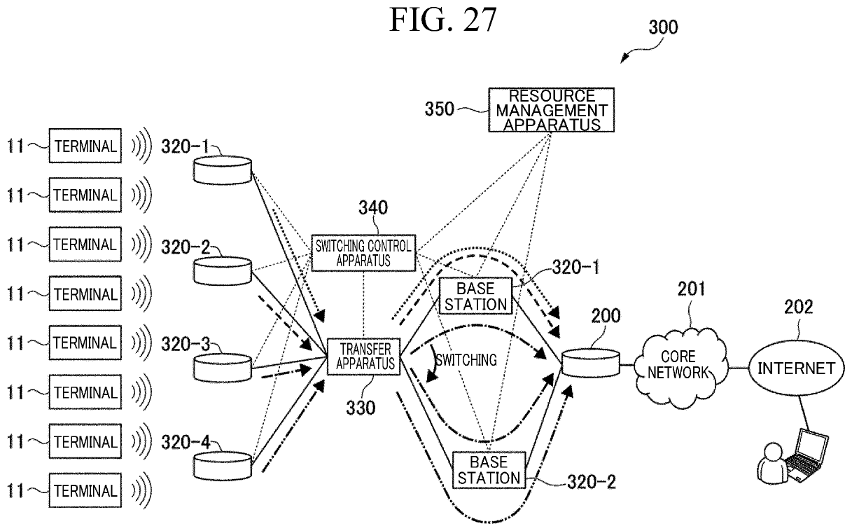

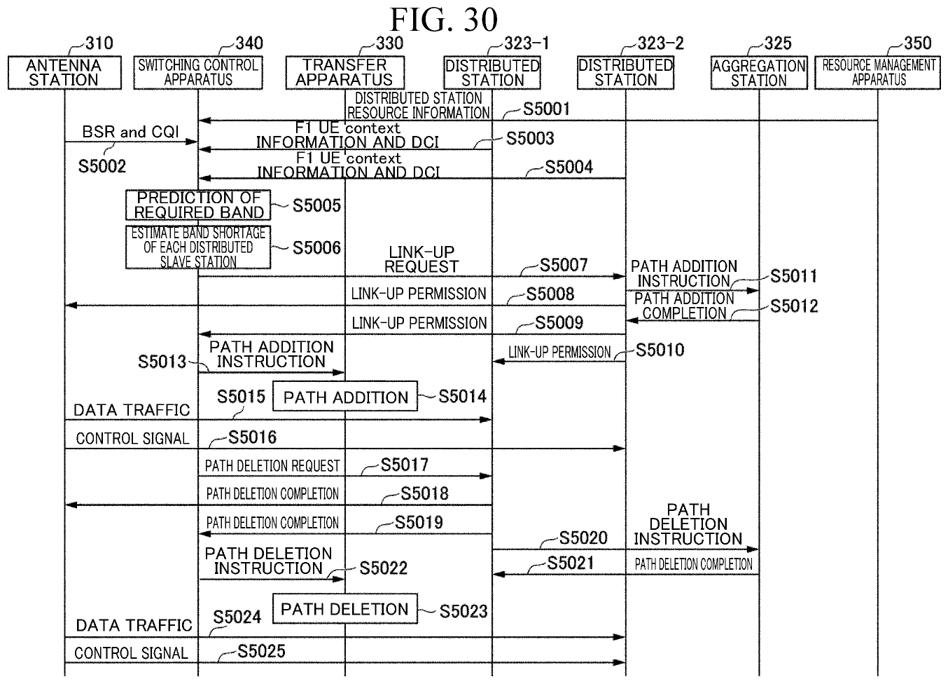

FIG. 27 is a diagram illustrating a configuration of a mobile NW system 300 according to the seventh embodiment. The mobile NW system 300 includes a terminal 11, an antenna station 310, a base station 320, a transfer apparatus 330, a switching control apparatus 340 and a resource management apparatus 350. The antenna station 310, the base station 320, the transfer apparatus 330, and the switching control apparatus 340 constitute a mobile NW. The base station 320 is a distributed station 323 and an aggregation station 325 illustrated in FIG. 30 to be described below. The base station 320 is connected to the core network 201 and the Internet 202 via the transfer apparatus 200. Hereinafter, J antenna stations 310 are described as antenna stations 310-1 to 310-J, and M base stations 320 (M is an integer equal to or greater than 2) are described as base stations 320-1 to 320-M. FIG. 27 illustrates an example in which J=4 and M=2. In the present embodiment, a bearer signal between the antenna station 310 and the base station 320 and a signal between the base station 320 and the transfer apparatus 200 are optical signals. The transfer apparatus 330 is an optical GW. A first port (not illustrated) of the transfer apparatus 330 is connected to the transmission path the antenna station 310, and a second port (not illustrated) is connected to the transmission path with the distributed station 323.

When the mobile NW system 300 performs switching between the antenna station 310 and the distributed station 323 according to band tightness of the distributed station 323 and an overload of processing, scheduling is performed at a layer upper than the switching control apparatus 340. Therefore, it is conceivable that the antenna station 310 transmits data to both the distributed station 323 that is a switching destination and the distributed station 323 that is a switching source. In this case, the antenna station 310 transmits a physical uplink shared channel (PUSCH) in which uplink data has been set to the distributed station 323 that is a switching source, and transmits a line quality signal used for a determination of next scheduling and information on a request amount (MAC layer C-plane) of the terminal to the distributed station 323 that is a switching destination.

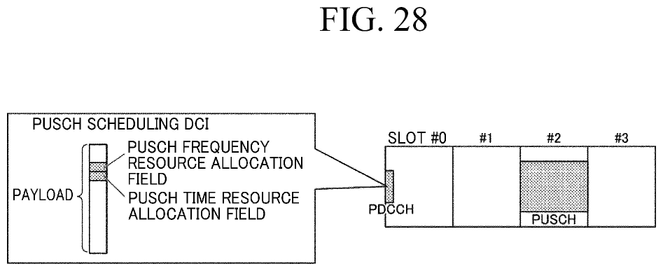

FIG. 28 is a diagram illustrating some of slots of a radio signal between the antenna station 310 and the terminal 11. In the 5G, the terminal transmits a scheduling request (SR), and the distributed station returns the DCI to allocate an uplink radio resource to the terminal. In another procedure of 5G, a PUSCH which is a physical channel for transmitting uplink data is allocated to the terminal in advance. When the uplink data is generated, the terminal transmits the uplink data through the PUSCH without transmitting the scheduling request. The allocation of frequency resources and time resources of the PUSCH is set in a downlink control channel (PDCCH) transmitted before the PUSCH.

In the present embodiment, the same operation as in the above-described embodiment is performed except that a buffer status report (BSR) and channel quality indicator (CQI) are used instead of the DCI of the above embodiment, F1 UE context information is used instead of the bearer information of the above-described embodiment, DCI is used instead of the band of the aggregation station 140, the antenna station 310 is used instead of the distributed station 130, and the distributed station 323 is used instead of central station 140. The BSR indicates a buffer amount of uplink data in the terminal 11. The CQI indicates the reception quality measured by the terminal 11.

A configuration of the distributed station 323 is the same as that of the distributed station 130 illustrated in FIG. 3. However, the first separator 1411 is connected to a transmission path with the transfer apparatus 330, and the second separator 1416 is connected to a transmission path with the aggregation station 325.

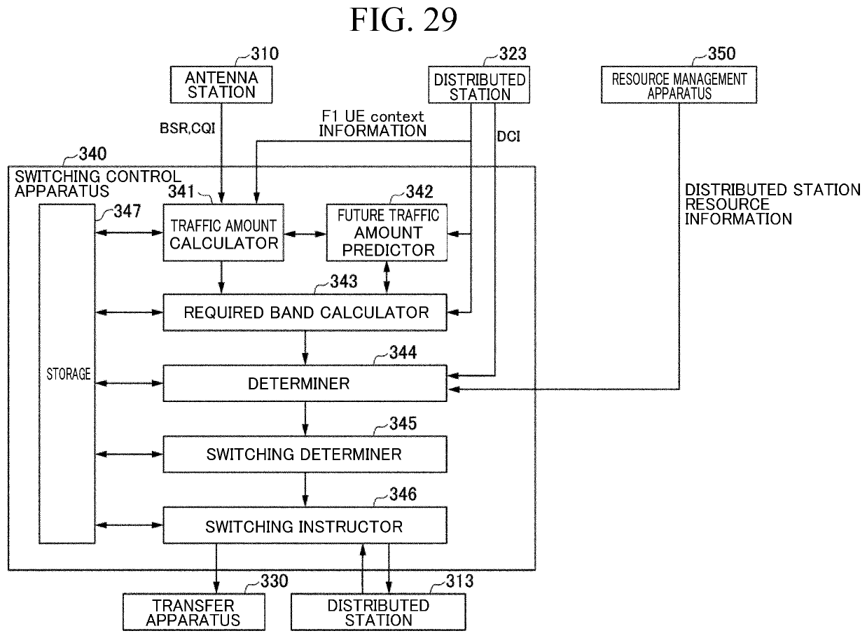

FIG. 29 is a block diagram illustrating a configuration of the switching control apparatus 340. The switching control apparatus 340 includes a traffic amount calculator 341, the future traffic amount predictor 342, a required band calculator 343, the determiner 344, a switching determiner 345, a switching instructor 346, and a storage 347.

The traffic amount calculator 341 calculates a predicted traffic amount in the next transmission period of each terminal 11 by using the BSR and COI acquired from each antenna station 310. The traffic amount calculator 341 sums the predicted traffic amounts of the terminals 11 under control for each antenna station 310, and calculates the predicted traffic amount in the next transmission period. The future traffic amount predictor 342 predicts the future traffic amount of the antenna station 310.

The required band calculator 343 receives the F1 UE context information from the distributed station 323. The F1 UE context information includes information on the antenna station 310 under control to which the distributed station 323 is connected. The required band calculator 343 calculates the required band of each distributed station 323 by using the predicted traffic amount of each antenna station 310 and connection information such as the F1 UE context information. When it is predicted that the path switching in the mobile NW system 300 is ended by the next transmission period, the predicted traffic amount used for calculation of the required band is the predicted traffic amount of the next transmission period calculated by the traffic amount calculator 341. When it is predicted that the path switching is not ended by the next transmission period, the predicted traffic amount used for calculation f the required band is the future traffic amount calculated by the future traffic amount predictor 342.

The determiner 344 sums predicted traffic amounts of antenna stations 310 under the control of the distributed stations 323 to calculate the required band of each distributed station 323. The determiner 344 may calculate a required band of the distributed station 323 on the basis of the DCI received from the distributed station 323. Further, the determiner 344 acquires information on the processable band of the distributed station 323 on the basis of the allocation resources of each distributed station 323 indicated by the distributed station resource information received from the resource management apparatus 350. The determiner 344 calculates the congestion amount of each distributed station 323 by using the required band and the processable band of the distributed station 323 calculated by the required band calculator 343. The congestion amount is calculated by subtracting the processable band from the required band of the distributed station 323. The determiner 344 determines that the congestion is predicted when the congestion amount exceeds a predetermined condition.

When the determiner 344 predicts congestion, the switching determiner 345 determines the antenna station 310 for connection destination switching and the distributed station 323 that is a switching destination so that the congestion amount in all the distributed station 323 is equal to or smaller than a predetermined amount on the basis of the required band and the congestion amount of each distributed station 323 and the predicted traffic amount of each antenna station 310. The switching instructor 346 instructs each apparatus to switch a transfer path so that an uplink signal from the antenna station 310 to which a connection destination is to be switched is transferred to the distributed station 323 that is a switching destination. The storage 347 stores data to be used in processing of each unit.

FIG. 30 is a sequence diagram illustrating a path switching procedure of the mobile NW system 300. In the figure, two distributed stations 323 are shown as distributed stations 323-1 and 323-2. The optical signal from the antenna station 310 to the distributed station 323-1 uses a wavelength A1.

The resource management apparatus 350 transmits the distributed station resource information to the switching control apparatus 340 (step S5001). The distributed station resource information indicates resources allocated to the distributed stations 323-1 and 323-2. The resource management apparatus 350 transmits the distributed station resource information to the switching control apparatus 340 every time the allocated resources change when the allocated resources to the distributed station 323 has changed. The switching control apparatus 340 calculates a maximum processable band for each distributed station 323 from resources allocated to the distributed stations 323-2.

Each antenna station 310 transmits the BSR and CQI received from the terminal 11 to the switching control apparatus 340 (step S5002). Each of the distributed stations 323-1 and 323-2 notifies a switching control apparatus 340 of the F1 UE context information indicating the antenna station 310 to which the own station is connected and DCI transmitted to the terminal 11 under control (step S5003 and step S5004). A transmission frequency of BSR and COI and a transmission frequency of DCI correspond to TTI.

The switching control apparatus 340 calculates the predicted traffic amount in each antenna station 310 on the basis of the received BSR and CQI. The switching control apparatus 340 calculates the required band of each distributed station 323 by summing the predicted traffic amounts of the antenna stations 310 connected to the distributed stations 323 for each distributed station 323 (step S5005). Alternatively, the switching control apparatus 340 calculates the required band of each distributed station 323 on the basis of the DCI.

The switching control apparatus 340 calculates a processable band of each distributed station 323 on the basis of the distributed station resource information. The switching control apparatus 340 calculates the congestion amount of each distributed station 323 on the basis of the processable band of each distributed station 323 and the required band of each distributed station 323 calculated in step S5005. The switching control apparatus 340 estimates the band shortage of the distributed station 323-1 by using the calculated congestion amount (step S5006).

The switching control apparatus 340 selects the distributed station 323-2 in which the band is estimated not to be insufficient, as an offload destination. The switching control apparatus 340 selects the antenna station 310 whose connection destination is changed to the distributed station 323-2 among some or all the antenna stations 310 connected to the distributed station 323-1. The selected antenna station 310 is described as the antenna station 310 that is a switching target. The switching control apparatus 340 transmits a link-up request to the distributed station 323-2 that is an offload destination (step S5007). The link-up request requests the distributed station 323-2 that is an offload destination to establish a link for receiving traffic using the optical signal at the wavelength λ2 from the antenna station 310 that is a switching target. For this link-up request, an RRCreconfig addition instruction is used.

When the distributed station 323-2 that is an offload destination establishes a link for receiving traffic using the optical signal at the wavelength λ2 from the antenna station 310 that is a switching target according to the link-up request, the distributed station 323-2 that is an offload destination transmits the link-up permission at the wavelength λ2 to the antenna station 310 that is a switching target, the switching control apparatus 340, and the distributed station 323-1 (steps S5008, S5009, and S5010). The link-up permission is an RRCreconfig addition completion notification.

On the other hand, the distributed station 323-2 transmits the path addition instruction to the aggregation station 325 that is a connection destination of the distributed station 323-2 according to the reception of the link-up request in step S5007 as a trigger (step S5011). The aggregation station 325 establishes a link with the distributed station 323-2 according to the path addition instruction, and further adds a path to the core network 201. The aggregation station 325 returns the completion of the path addition to the distributed station 323-2 (step S5012).

The switching control apparatus 340 transmits the path addition instruction to the transfer apparatus 330 on the basis of RRCreconfig information set in the link-up permission received from the distributed station 323-2 (step S5013). The path addition instruction is an instruction to add a path for outputting the optical signal at the wavelength λ2 input from the first port to which a transmission line with the antenna station 310 that is a switching target is connected to the second port to which a transmission line with the distributed station 323-2 is connected. The transfer apparatus 330 adds the transfer path according to the received path addition instruction (step S5014).

The antenna station 310 that is a switching target transmits data traffic using an optical signal at the wavelength A1 and a control signal using an optical signal at a wavelength λ2 (steps S5015 and S5016). The data traffic is a U-Plane signal, and the control signal is a C-Plane signal. The transfer apparatus 330 transfers the data traffic to the distributed station 323-1, and transfers the control signal to the distributed station 323-2.

The switching control apparatus 340 transmits a path deletion request to the distributed station 323-1 (step S5017). The path deletion request requests deletion of a path between the distributed station 323-1 and the antenna station 310 that is a switching target. The distributed station 323-1 deletes a path with the antenna station 310 that is a switching target according to the received path deletion request. The distributed station 323-1 transmits the completion of the path deletion to the antenna station 310 and the switching control apparatus 340 (steps S5018 and S5019).

The distributed station 323-1 further transmits the path deletion instruction from the antenna station 310 that is a switching target to the aggregation station 325 with the reception of the path deletion request transmitted by the switching control apparatus 340 in step S5017 as a trigger (step S5020). The aggregation station 325 that is a connection destination of the distributed station 323-1 deletes a path with the distributed station 323-1 according to the path deletion instruction. The aggregation station 325 returns the completion of the path deletion to the distributed station 323-1 (step S5021).

On the other hand, the switching control apparatus 340 transmits the path deletion instruction to the transfer apparatus 330 with the reception of the path deletion completion from the distributed station 323-1 as a trigger (step S5022). The path deletion instruction is an instruction to delete a path for outputting an optical signal input from the first port to which the transmission line with the antenna station 310 that is a switching target is connected to the second port to which a transmission line with the distributed station 323-1 is connected. The transfer apparatus 330 deletes a path to the distributed station 323-1 according to the received path deletion instruction (step S5023).

The antenna station 310 that is a switching target transmits data traffic and a control signal using the optical signal at the wavelength λ2 (steps S5024 and S5025). The transfer apparatus 330 transfers the data traffic and the control signal to the distributed station 323-2. In the above description, a case in which the data traffic and the control signal are optical signals of the same wavelength has been described, but different wavelengths may be used.

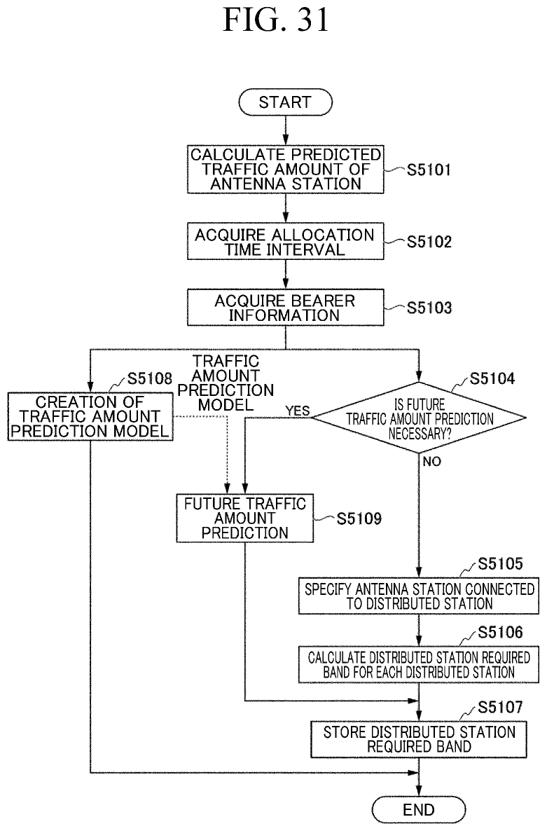

Next, an example of a processing procedure of the switching control apparatus 340 will be described with reference to FIGS. 31 to 35.

FIG. 31 is a flow diagram illustrating band control processing of the switching control apparatus 340. Each antenna station 310 transmits the BSR and COI received from the terminal 11 to the switching control apparatus 340. The traffic amount calculator 341 calculates a predicted traffic amount RU(i) of each antenna station 310 in the next transmission period U(i) from time t(i) to t(i+1) on the basis of the received BSR and CQI (step S5101). Further, the traffic amount calculator 341 calculates the allocation time interval T(i) from a difference between the time t(i) and the time t(i+1) (step S5102). The traffic amount calculator 341 stores the predicted traffic amount RU(i) of each antenna station 310 and the allocation time interval T(i) in the storage 347.

The required band calculator 343 receives the F1 UE context information from the distributed station 323 and stores the F1 UE context information in the storage 347. The required band calculator 343 reads the F1 UE context information from the storage 347 (step S5103). The traffic amount calculator 341 determines whether or not the prediction of the future traffic amount is necessary (step S5104). In the mobile NW system 300, a time required from the instruction of path switching by the switching control apparatus 340 to the completion of switching is defined as a switching time Td. This switching time Td is processing from step S5007 to step S5023 of FIG. 30. When the switching time Td is equal to or less than the allocation time interval T(i) (Td<+T(i)), the traffic amount calculator 341 determines that the prediction of the future traffic amount is unnecessary (step S5104: No).

The required band calculator 343 specifies the antenna station 310 connected to each distributed station 323 from the F1 UE context information (step S5105). The required band calculator 343 sums the predicted traffic amounts RU(i) of the respective antenna stations 310 under control, for each distributed station 323, and calculates the distributed station required band DUr(i) in the transmission period U(i) (step S5106). The required band calculator 343 stores the distributed station required band DUr(i) of each distributed station 323 in the storage 347, and activates the determiner 344 (step S5107).

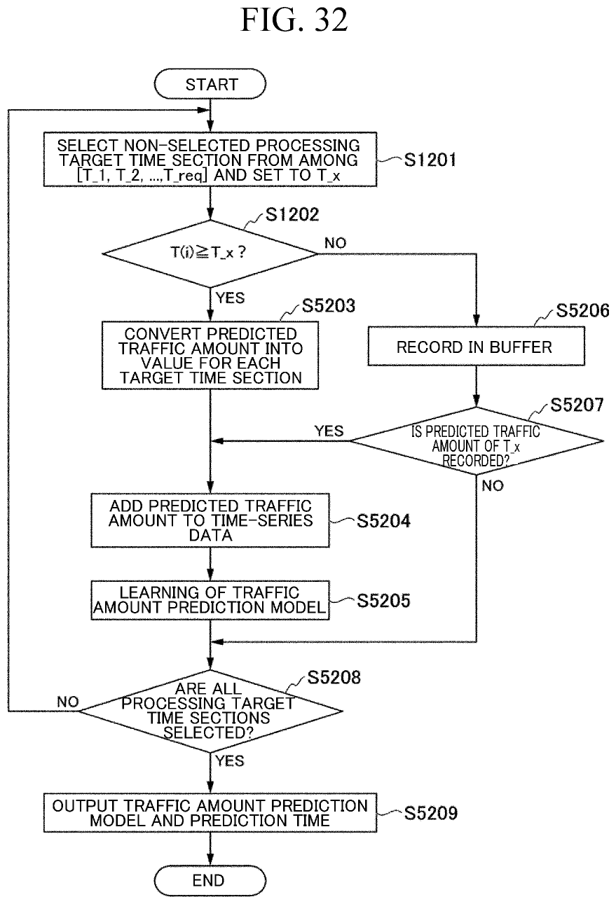

On the other hand, the future traffic amount predictor 342 creates the traffic amount prediction model in parallel with the processing of step S5104 (step S5108). Details of the creation of the traffic amount prediction model will be described below with reference to FIG. 32.

In step S5104, when the switching time Td is longer than the allocation time interval T(i) (Td>T(i)), the traffic amount calculator 341 determines that the prediction of the future traffic amount is necessary (step S5104: Yes). The traffic amount calculator 341 instructs the future traffic amount predictor 342 to predict the future traffic amount.

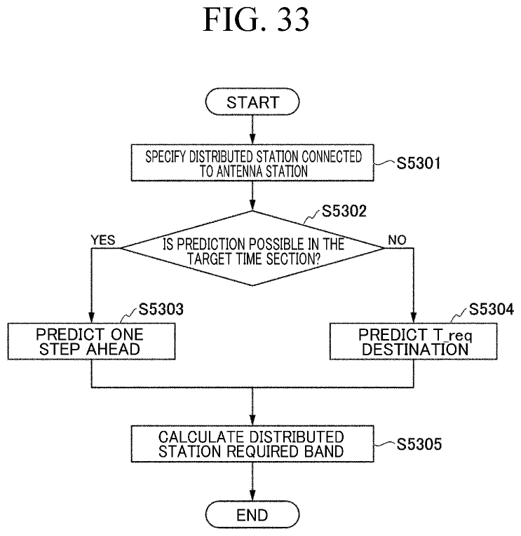

The future traffic amount predictor 342 predicts the future traffic amount RU(i+1) of each antenna station 310 in the transmission period U(i+1) from the time t(i+1) to a time t(i+2) by using the traffic amount prediction model created in step S5108 (step S5109). Details of the prediction processing will be described below with reference to FIG. 33.

The required band calculator 343 sums future traffic amounts RU(i+1) of the antenna stations 310 under control for each distributed station 323 to calculate the distributed station required band DUr(i+1) in the transmission period U(i+1). The required band calculator 343 stores the distributed station required band DUr(i+1) of each distributed station 323 in the storage 347, and activates the determiner 344 (step S5107).

The required band calculator 343 may calculate the distributed station required band DUr(i) by using DCI received from the distributed station 323 instead of processing of steps S5105 and S5106. In this case, the switching control apparatus 340 does not execute processing of steps S5104, S5018 and S5108 of FIG. 31 and processing of FIGS. 32 and 33 to be described below.

FIG. 32 is a flow diagram traffic amount prediction model creation processing of the future traffic amount predictor 342. FIG. 32 illustrates detailed processing in in step S5108 of FIG. 31. In FIG. 32, the same processing as the traffic amount prediction model creation processing of the first embodiment illustrated in FIG. 8 is denoted by the same reference sign and descriptions thereof will be omitted.

The storage 347 stores K time sections T_1, T_2, . . . , T_k-1, and T_req of the processing target in advance. The future traffic amount predictor 342 selects one of the time sections T_1 to T_req, and sets the time section to T_x (step S1201).

The future traffic amount predictor 342 determines whether or not the allocation time interval T(i) is equal to or more than the time interval T_x (step S1202).

When it is determined that the allocation time interval T(i) is equal to or longer than the time interval T_x (step S1202: Yes), the future traffic amount predictor 342 converts the predicted traffic amount RU(i) of the antenna station 310 into a predicted traffic amount for each time interval T_x by the same processing as step S1203 of FIG. 8 (step S5203). That is, the future traffic amount predictor 342 calculates the occurrence of the predicted traffic amount RU_T_x of the predicted traffic amount RU(i)×(time interval T_x/allocation time interval T(i)) for each time interval T_x between time t(i) and time t(i+1).

The future traffic amount predictor 342 adds the predicted traffic amount calculated in step S5203 to the time-series predicted traffic amount calculated in the past for the time section T_x for each antenna station 310, and stores the resultant amount in the storage 347 (step S5204). The future traffic amount predictor 342 learns the traffic amount prediction model of the time section T_x by using the time-series prediction traffic amount of the antenna station 310 of the time section T_x stored in the storage 347 through the same processing as step S1205 of FIG. 8 (step S5205).

For example, the time-series predicted traffic amount of the antenna station 310 in the time section T_x are RU_T_x (P), RU_T_x (P−1), RU_T_x (P−2), . . . , RU_T_x (1) (P is an integer equal to or greater than 2) in order of newer time. The future traffic amount predictor 342 generates learning data with RU_T_x (p) as correct output data and RU_T_x (p−1) to RU_T_x (p-q) as input data while sequentially subtracting the value of p from P (q is an integer equal to or greater than 1). The future traffic amount predictor 342 learns the traffic amount prediction model representing correspondence between input data and output data by using the generated learning data.

On the other hand, in step S1202, when it is determined that the allocation time interval T(i) is smaller than the time interval T_x (step S1202: No), the future traffic amount predictor 342 performs processing of step S5206. The future traffic amount predictor 342 records the predicted traffic amount RU(i) of the antenna station 310-j (j is an integer equal to or greater than 1 and equal to or smaller than J) in a buffer corresponding to the antenna station 310-j and the time section T_x in the future traffic amount predictor 342 or the storage 347 (step S5206). The future traffic amount predictor 342 determines whether or not the predicted traffic amount for the time section T_x is recorded in the buffer corresponding to the time section T_x (step S5207). The future traffic amount predictor 342 determines whether or not a predicted traffic amount for a time section T_x is recorded in a buffer corresponding to each antenna station 310 and each antenna station (step S5207).

When it is determined that the predicted traffic amount for the time section T_x is not recorded in the buffer corresponding to the time section T_x (step S5207: No), the future traffic amount predictor 162 performs processing from step S1208. When it is determined that the predicted traffic amount for the time section T_x is recorded in the buffer corresponding to the time section T_x for each antenna station 310 (step S5207: Yes), the future traffic amount predictor 342 performs processing of step S5204. That is, the future traffic amount predictor 342 reads the predicted traffic amounts RU(i−T_x/T(i)+1) to RU(i) from the buffer corresponding to the time interval T_x and sums the predicted traffic amounts to obtain RU_T_x (P).

The storage 347 stores time-series predicted traffic amounts RU_T_x (1) to RU_T_x (P−1) calculated in the past for the time section T_x. The future traffic amount predictor 342 adds a newly calculated predicted traffic amount RU_T_x (P) to the predicted traffic amounts RU_T_x (1) to RU_T_x (P−1) for each antenna station 310 and stores a result thereof in the storage 347 (step S5204). The future traffic amount predictor 342 performs processing of step S5205, and learns the traffic amount prediction model by using the time-series prediction traffic amount of the time section T_x.

After the processing of step S5205, or when NO is determined in step S5207, the future traffic amount predictor 342 determines whether all the K time sections of the processing target have been selected (step S1208). When there is a non-selected time section (step S5208: No), the future traffic amount predictor 342 repeats processing from step S1201. When it is determined that all the K time sections are selected (step S1208: Yes), the future traffic amount predictor 342 stores the traffic amount prediction model corresponding to each of the K time sections and a prediction time of the traffic amount prediction model in the storage 347 (step S5209).

The future traffic amount predictor 342 may execute processing of steps S1202 to S5207 in parallel for each of K the time sections.

FIG. 33 is a flow diagram illustrating the future traffic amount prediction processing of the future traffic amount predictor 342. FIG. 33 illustrates specific processing of the determination in step S5109 of the FIG. 31. The future traffic amount predictor 342 specifies the antenna station 310 connected to each distributed station 323 on the basis of the F1 UE context information (step S5301). The future traffic amount predictor 342 determines whether or not the prediction of the future traffic amount is possible by time t(i+1) when the next the transmission period U(i) is ended by the same processing as step S1302 of FIG. 9 (step S5302).

The future traffic amount predictor 342 performs processing of step S5303 when it is determined that the future traffic amount can be predicted by the end of the next the transmission period U(i) (step S5302: Yes). The future traffic amount predictor 342 inputs p time-series predicted traffic amounts RU(P) to RU(P−p+1) from the latest one of the allocation time intervals T(i) to the traffic amount prediction model created for the allocation time interval T(i) for each antenna station 310. The future traffic amount predictor 342 calculates the future traffic amount RU(i+1) of each antenna station 310 in the transmission period U(i+1) from time t(i+1) to time t(i+2) (step S5303). t(i+2)=t(i+1)+T(i). The future traffic amount predictor 342 writes the calculated future traffic amount RU(i+1) of each antenna station 310 to the storage 367.

The future traffic amount predictor 342 performs processing of step S5304 when it is determined that the prediction of the future traffic amount is impossible until the end of the next the transmission period U(i) (step S5302: No). The future traffic amount predictor 342 sums time-series predicted traffic amounts of the allocation time interval T(i) in order of newer traffic amounts by T_req/T(i) for each antenna station 310 to calculate time-series predicted traffic amounts of the time interval T_req (for example, 5 ms). The future traffic amount predictor 342 inputs q time-series predicted traffic amounts from the latest one of the time sections T_req to the traffic amount prediction model created for the time section T_req for each antenna station 310. Thus, the future traffic amount predictor 162 calculates the future traffic amount RUreq(i+1) of each antenna station 310 in the transmission period U(i+1) from the time t(i+1) to the time t(i+2) (step S5304). t(i+2)=t(i+1)+T_req. The future traffic amount predictor 342 writes the calculated future traffic amount DUreq(i+1) of each antenna station 310 to the storage 347.

The required band calculator 343 sums the future traffic amount RU(i+1) calculated in step S5303 or the future traffic amount RUreq(i+1) calculated in step S5304 with respect to each antenna station 310 under control for each distributed station 323 to calculate the distributed station required band DUr(i+1) in the transmission period U(i+1) (step S5305). In step S5107 of FIG. 31, the future traffic amount predictor 342 stores the distributed station required band DUr(i+1) of each distributed station 323 in the storage 347.

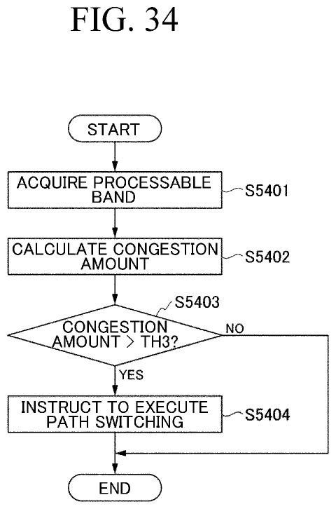

FIG. 34 is a flow diagram illustrating congestion determination processing of the determiner 344. The determiner 344 acquires a processable band of each distributed station 323 (step S5401). Specifically, the determiner 344 acquires information on the allocated resource of the distributed station 323 from the distributed station resource information received from the resource management apparatus 350. The allocated resource is the number of cores of the distributed station 323, an occupancy rate of the cores, or a resource block in the frequency direction. The determiner 344 calculates a processable band Y resource from the allocated resource amount indicated by the distributed station resource information on the basis of the relationship between the allocated resource amount and the processable band stored in advance.

The determiner 344 reads the distributed station required band DUr(i) or DUr(i+1) of the distributed station 323 stored in the storage 367 in step S5107 of FIG. 31 by the future traffic amount predictor 342, and defines the distributed station required band as the required band Y_traffic. The determiner 344 calculates the congestion amount Y_buf using the following equation (3) for each distributed station 323 (step S5402).

Y_buf=Y_traffic−Y_resource (3)

The determiner 344 may perform calculation of the congestion amount Y_buf of each distributed station 323 in parallel or may sequentially perform the calculation. The determiner 344 determines whether or not the congestion amount Y_buf of any of the distributed stations 323 exceeds the threshold TH3 (TH3>=0) (step S5403). When the congestion amount Y_buf is equal to or smaller than the threshold TH3, the determiner 344 determines that congestion does not occur, and ends the processing (step S5403: No). That is, the switching control apparatus 340 does not execute the path switching. On the other hand, when the congestion amount Y_buf exceeds the threshold TH3, the determiner 344 determines that congestion occurs (step S5403: Yes), and instructs the switching determiner 345 to execute path switching (step S5404).

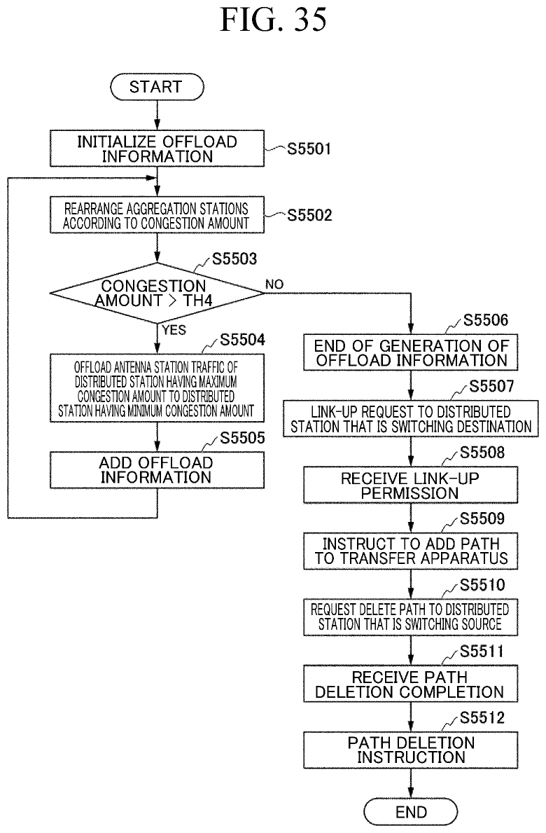

FIG. 35 is a flow diagram illustrating path switching control processing of the switching control apparatus 340. The switching determiner 345 starts the processing of FIG. 35 when the execution of the path switching is instructed from the determiner 344 in step S5404 of FIG. 34.

The switching determiner 345 initializes the offload information stored in the storage 347 (step S5501). The switching determiner 345 generates load information in which the distributed station 323 is associated with the congestion amount of the distributed station 323, the antenna station 310 under control, and the predicted traffic amount of the antenna station 310 under control. The switching determiner 345 arranges the load information in the order of the congestion amount and writes the load information in the storage 347 (step S5502). The predicted traffic amount is the predicted traffic amount RU(i) used when the distributed station required band DUr(i) is calculated in step S5106, the predicted traffic amount RU(i+1) calculated in step S5303, or the predicted traffic amount RUreq(i+1) calculated in step S5304.

The switching determiner 345 determines whether or not there is load information in which a congestion amount exceeding a threshold TH4 (TH4>=0) is set (step S5503). The threshold TH4 may be the same as the threshold TH3 used in step S5403 of FIG. 34. When it is determined that there is a congestion amount exceeding the threshold TH4 (step S5503: Yes), the switching determiner 345 executes processing of step S5504. That is, the switching determiner 345 refers to the load information to specify the distributed station 323-n1 (m1 is an integer equal to or greater than 1 and equal to or smaller than M) having the largest congestion amount and the distributed station 323-n2 (m2 is an integer equal to or greater than 1 and equal to or smaller than M; m1/m2) having the smallest congestion amount. The switching determiner 345 selects the antenna station 310 having the largest predicted traffic as the antenna station 310 that is a switching target among the antenna stations 310 under the control of the distributed stations 323-n1. The switching determiner 345 changes the antenna station 310 that is a switching target from under the distributed station 323-n1 to under the distributed station 323-n2 (step S5504).

The switching determiner 345 associates switching source distributed station information indicating the distributed stations 323-n1, switching destination distributed station information indicating the distributed stations 323-n2, and switching target antenna station information indicating the antenna station 310 that is a switching target with one another, and sets these to the offload information (step S5505). The switching determiner 345 repeats processing from step S5502. In step S5502, the switching determiner 345 deletes the predicted traffic amount of the antenna station 310 that is a switching target and the antenna station 310 that is a switching target from the load information of the distributed station 323-n1. The switching determiner 345 updates the degree of congestion set in the load information of the distributed stations 323-n1 to a value obtained by subtracting the predicted traffic amount of the antenna station 310 that is a switching target. Further, the switching determiner 345 adds the predicted traffic amount of the antenna station 310 that is a switching target and the antenna station 310 that is a switching target to the load information of the distributed stations 323-n2. The switching determiner 345 updates the degree of congestion set in the load information of the distributed stations 323-n2 to a value when the predicted traffic amount of the antenna station 310 that is a switching target is added. The switching determiner 345 rearranges the load information of the distributed stations 323-n1 and the updated load information of the distributed stations 323-n2 according to the congestion degree.

When it is determined that there is no congestion amount exceeding the threshold TH4 (step S5504: No), the switching determiner 345 ends generation of offload information and instructs the switching instructor 346 to start switching (step S5506).

The switching instructor 346 reads switching source distributed station information, switching destination distributed station information, and switching target antenna station information from the off-road information. The switching instructor 346 transmits a link-up request for requesting establishment of a link for receiving traffic from the antenna station 310 that is a switching target to the distributed station 323 indicated by the switching destination distributed station information (step S5507, and step S5007 in FIG. 30). The switching instructor 346 receives the link-up permission as a response corresponding to the link-up request from the distributed station 323 that is a switching destination (step S5508, and step S5009 in FIG. 30). The switching instructor 346 transmits the path addition instruction from the antenna station 310 that is a switching target to the distributed station 323 that is a switching destination to the transfer apparatus 330 (steps S5509, and step S5013 in FIG. 30).

The switching instructor 346 transmits a path deletion request for deleting the path with the antenna station 310 that is a switching target to the distributed station 323 that is a switching source (steps S5510 and S5017 in FIG. 30). The switching instructor 346 receives the path deletion completion as a response to the path deletion request from the distributed station 323 that is a switching source (step S5511, and step S5018 in FIG. 30). The switching control apparatus 340 transmits the path deletion instruction for deleting a transfer path between the antenna station 310 that is a switching target and the distributed station 323 that is a switching source to the transfer apparatus 330 (steps S5512, and S5022 in FIG. 30).

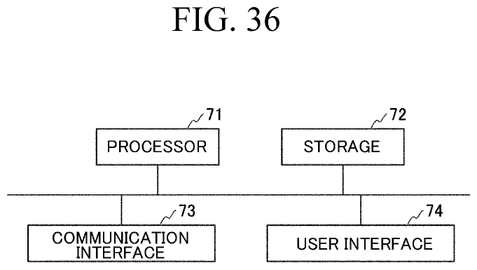

An example of the hardware configuration of the Switching control apparatuses 160, 160a, 160b, 160c, and 340 will be described. FIG. 36 is an apparatus configuration diagram illustrating an example of a hardware configuration of the switching control apparatuses 160, 160a, 160b, 160c, and 340. The switching control apparatuses 160, 160a, 160b, 160c, and 340 include a processor 71, a storage 72, a communication interface 73, and a user interface 74.

The processor 71 is a central processing unit that performs calculation or control. The processor 71 is, for example, a CPU. The processor 71 reads a program from the storage 72 and performs the read program. Some of the Switching control apparatuses 160, 160a, 160b, 160c, and 340 may be realized by using hardware such as an application specific integrated circuit (ASIC), a programmable logic device (PLD), or a field programmable gate array (FPGA). The storage 72 has a work area and the like used when the processor 71 performs various programs. The communication interface 73 is used to communicatively connect to another apparatus. The user interface 74 is an input device such as a keyboard, a pointing device (mouse, tablet, or the like), buttons, or a touch panel, or a display apparatus such as a display. An artificial operation is input by the user interface 74. For example, information of an upper limit layer and the information of a lower limit layer are input by the user interface 74.

The switching control apparatuses 160, 160a, 160b, 160c, and 340 may be realized by a plurality of computer apparatuses connected to a network. In this case, each functional unit of the switching control apparatuses 160, 160a, 160b, 160c, and 340 can be arbitrarily realized by any one of the plurality of computer apparatuses. Further, the same functional unit may be realized by a plurality of computer apparatuses.

According to the above-described embodiment, the transmission system includes the plurality of optical transmission apparatuses, the transfer apparatus, and the switching control apparatus. The transmission system is, for example, the mobile NW system 10, 100, 101, 102, and 300 of the embodiments. The plurality of transmission apparatuses constitute a communication network hierarchized into a plurality of layers. Each transmission apparatus transfers the received signal to a hierarchy next above. The transmission apparatus is, for example, the antenna stations 12, 120, and 310, the distributed stations 13, 130, and 323, and the aggregation stations 14, 140, and 325. The communication network is, for example, a mobile NW. The transfer apparatus transfers a signal transmitted from the first transmission apparatus that is a transmission apparatus of a predetermined layer among the plurality of layers to the second transmission apparatus serving as the connection destination of the first transmission apparatus among the plurality of second transmission apparatuses that are transmission apparatuses of a layer next above the predetermined layer. The transfer apparatus is, for example, the transfer apparatus 15, 150, or 330 of the embodiments. The switching control apparatus switches the second transmission apparatus serving as the connection destination of the first transmission apparatus. The switching control apparatus is, for example, the switching control apparatus 16, 160, 160a, 160b, 160c, or 340 of the embodiments.

The switching control apparatus includes the traffic amount calculator, the required band calculator, the determiner, the switching determiner, and the switching instructor. The traffic amount calculator calculates a traffic amount of a signal received by each of the first transmission apparatuses via a transmission apparatus in a layer lower than the predetermined layer in a predetermined period on the basis of the allocation of radio resources to the terminal that wirelessly transmits a signal to the transmission apparatus of the lowest layer. The required band calculator calculates, for each second transmission apparatus, processing capability predicted to be required in the second transmission apparatus on the basis of the traffic amount in the first transmission apparatus with the second transmission apparatus as a connection destination. The determiner determines whether congestion occurs in the second transmission apparatus on the basis of the predicted processing capability. The switching determiner determines that connection destinations of at least some of the first transmission apparatuses with the second transmission apparatus in which congestion is determined to occur as a connection destination, are switched to the second transmission apparatus in which congestion is determined not to occur. In this case, the switching determiner switches the connection destination of the first transmission apparatus so that congestion does not occur in any of the second transmission apparatuses on the basis of the traffic amount of the first transmission apparatus. The switching instructor instructs the transfer apparatus to transfer a signal transmitted from the switching target transmission apparatus that is the first transmission apparatus in which the connection destination is determined to be switched, to the second transmission apparatus that is a connection destination after switching of the switching target transmission apparatus on the basis of the determination of the switching determiner.

The switching instructor performs processing for transmitting an instruction to receive a signal from the switching target transmission apparatus to a second transmission apparatus serving as a switching destination, the second transmission apparatus serving as a switching destination being the second transmission apparatus serving as a connection destination after switching of the switching target transmission apparatus, and processing for transmitting an instruction to stop the reception of the signal from the switching target transmission apparatus to a second transmission apparatus serving as a switching source, the second transmission apparatus serving as a switching source being the second transmission apparatus serving as a connection destination before switching of the switching target transmission apparatus. For example, the reception instruction is the path addition instruction transmitted in step S1008 of the embodiment, and the reception stop is the path deletion instruction transmitted in step S1009 of the embodiment. The second transmission apparatus serving as a switching destination transmits a reception instruction response to the switching target transmission apparatus, the switching control apparatus, and the second transmission apparatus serving as a switching source when reception of a signal from the switching target transmission apparatus is possible on the basis of the reception instruction. For example, the reception instruction response is a bearer response transmitted in steps S1010 to S1012 of the embodiment. The second transmission apparatus serving as a switching source transmits a reception stop response to the switching control apparatus and the second transmission apparatus serving as a switching destination when reception of a signal from the switching target transmission apparatus is stopped on the basis of the reception stop instruction. For example, the reception stop response is the bearer response transmitted in steps S1013 and S1014 of the embodiment. The second transmission apparatus serving as a switching destination instructs switching of connection to an upper network of the transmission system when the reception stop response is received from the second transmission apparatus serving as a switching source in addition to the reception instruction from the switching target transmission apparatus transmitted by the switching instructor. The switching instructor of the switching control apparatus instructs the transfer apparatus to transfer the signal transmitted from the switching target transmission apparatus to the second transmission apparatus serving as a switching destination.

The plurality of transmission apparatuses include the antenna station that converts a radio signal received from a terminal into a wired signal and transmits the converted signal, the one or more distributed stations that receive signals from one or more antenna stations under control, and the aggregation station that receives signals from one or more distributed stations under control and transfers the received signals to the upper network. The first transmission apparatus is a distributed station, and the second transmission apparatus is an aggregation station. Alternatively, the first transmission apparatus is an antenna station, and the second transmission apparatus is a distributed station.

The first transmission apparatus may transmit a signal to the second transmission apparatus through an optical signal. Each time the radio resource is allocated to the terminal, the switching control apparatus may be notified of the allocation of the radio resources.

The determiner may determine whether or not congestion occurs in the second transmission apparatus by using the processing capability of the second transmission apparatus, the processing amount in the second transmission apparatus, and the processing capability predicted for the second transmission apparatus. The processing amount in the second transmission apparatus is, for example, a band of a signal buffered in the second transmission apparatus.

The determiner may calculate the processing capability of the second transmission apparatus on the basis of the amount of resources allocated to the second transmission apparatus.

The switching control apparatus may further include the future traffic amount calculator. The future traffic amount calculator calculates the future traffic amount that is a traffic amount of the first transmission apparatus in the next period on the basis of the traffic amount in the predetermined period. The required band calculator calculates, for each second transmission apparatus, processing capability predicted to be required in the second transmission apparatus on the basis of the future traffic amount in the first transmission apparatus with the second transmission apparatus as a connection destination.

Although the embodiments of the present invention have been described in detail with reference to the drawings, a specific configuration is not limited to the present embodiments, and design within the scope of the gist of the present invention, and the like are included.

### REFERENCE SIGNS LIST

10 Mobile NW System
11 Terminal
12-1, 12-2 Antenna station
13-1, 13-2 Base station
14-1, 14-2 Aggregation station
15 Transfer apparatus
16 Switching control apparatus
20 Upper NW
71 Processor
72 Storage
73 Communication interface
74 User Interface
100, 101, 102, 300 Mobile NW system
120, 120-1 to 120-4, 310, 310-1 to 310-4 Antenna station
130, 130-1 to 130-4, 323-1, 323-2 Distributed stations
131 User data transmitter and receiver
132 Communicator
133 Controller
140, 140-1, 140-2, 325 Aggregation stations
141 User data transmitter and receiver
142 Communicator
143 Controller
150, 150a, 330 Transfer apparatus
160, 160a, 160b, 160c, 340 Control apparatus
161, 341 Traffic amount calculator
162, 342 Future traffic amount predictor
163, 343 Required band calculator
164, 344 Determiner
165, 345 Switching determiner
166, 346 Switching instructor
167, 347 Storage
168 Required band predictor
170, 350 Resource management apparatus
181 Wireless control information acquisition apparatus
182 Switching control apparatus
191 Integrated control apparatus
192 Switching control apparatus
200 Transfer apparatus
201 Core network
202 Internet
320-1, 320-2 Base station
1311, 1411 First separator
1312, 1412 First optical-electro converter
1313, 1414 Signal generator
1314-1415 First electro-optical converter
1315, 1416 Second separator
1316, 1417 Second optical-electro converter
1317, 1418 Signal generator
1318, 1419 Second electro-optical converter
1413 Buffer

1. A transmission system comprising:
a plurality of transmission apparatuses configured to constitute a communication network hierarchized into a plurality of layers and transfer a received signal to a layer next above;
a transfer apparatus configured to transfer a signal transmitted from a first transmission apparatus serving as a transmission apparatus of a predetermined layer among the plurality of layers to a second transmission apparatus serving as a connection destination of the first transmission apparatus among the plurality of second transmission apparatuses serving as transmission apparatuses of a layer next above the predetermined layer; and
a switching control apparatus configured to switch the second transmission apparatus serving as the connection destination of the first transmission apparatus,
wherein the switching control apparatus comprises
a traffic amount calculator configured to calculate a traffic amount of a signal received via a transmission apparatus of a layer lower than the predetermined layer in a predetermined period by the first transmission apparatus, on the basis of allocation of radio resources to a terminal wirelessly transmitting a signal to a lowermost transmission apparatus;
a required band calculator configured to calculate, for each second transmission apparatus, a processing capability predicted to be required in the second transmission apparatus on the basis of the traffic amount in the first transmission apparatus with the second transmission apparatus as a connection destination;
a determiner configured to determine whether congestion occurs in the second transmission apparatus on the basis of the predicted processing capability;
a switching determiner configured to determine that connection destinations of at least some of the first transmission apparatuses with the second transmission apparatus as a connection destination in which congestion is determined to occur are switched to the second transmission apparatus in which congestion is determined not to occur; and
a switching instructor configured to instruct the transfer apparatus to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination of the switching determiner.

2. The transmission system according to claim 1, wherein the switching instructor performs processing for transmitting an instruction to receive a signal from the switching target transmission apparatus to a second transmission apparatus serving as a switching destination, the second transmission apparatus serving as a switching destination being the second transmission apparatus serving as a connection destination after switching of the switching target transmission apparatus, and processing for transmitting an instruction to stop the reception of the signal from the switching target transmission apparatus to a second transmission apparatus serving as a switching source, the second transmission apparatus serving as a switching source being the second transmission apparatus serving as a connection destination before switching of the switching target transmission apparatus,
the second transmission apparatus serving as a switching destination transmits a reception instruction response to the switching target transmission apparatus, the switching control apparatus, and the second transmission apparatus serving as a switching source when reception of a signal from the switching target transmission apparatus is possible on the basis of the reception instruction,
the second transmission apparatus serving as a switching source transmits a reception stop response to the switching control apparatus and the second transmission apparatus serving as a switching destination when reception of a signal from the switching target transmission apparatus is stopped on the basis of the reception stop instruction,
the second transmission apparatus serving as a switching destination instructs switching of connection to an upper network of the transmission system when the reception stop response is received from the second transmission apparatus serving as a switching source in addition to the reception instruction, and
the switching instructor instructs the transfer apparatus to transfer the signal transmitted from the switching target transmission apparatus to the second transmission apparatus serving as a switching destination when the reception stop response is received.

3. A switching control apparatus comprising:
a traffic amount calculator configured to calculate a traffic amount of a signal received via a transmission apparatus of a layer lower than a predetermined layer among a plurality of layers configured to constitute a communication network hierarchized into a plurality of layers and transfer a received signal to a layer next above, in a predetermined period by a first transmission apparatus serving as a transmission apparatus of the predetermined layer, on the basis of allocation of radio resources to a terminal wirelessly transmitting a signal to a lowermost transmission apparatus among the plurality of transmission apparatuses;
a required band calculator configured to calculate, for each second transmission apparatus serving as a transmission apparatus of a layer next above the first transmission apparatus, a processing capability predicted to be required in the second transmission apparatus on the basis of the traffic amount in the first transmission apparatus with the second transmission apparatus as a connection destination;
a determiner configured to determine whether or not congestion occurs in the second transmission apparatus on the basis of the predicted processing capability;
a switching determiner configured to determine that connection destinations of at least some of the first transmission apparatuses with the second transmission apparatus in which congestion is determined to occur as a connection destination are switched to the second transmission apparatus in which congestion is determined not to occur; and
a switching instructor configured to instruct a transfer apparatus transferring a signal transmitted from the first transmission apparatus to the second transmission apparatus serving as the connection destination of the first transmission apparatus among the plurality of second transmission apparatuses to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination of the switching determiner.

4. The switching control apparatus according to claim 3, wherein a plurality of the transmission apparatus comprises an antenna station configured to convert a radio signal received from the terminal into a wired signal and transmit the converted signal;
a distributed station configured to receive the signals from one or more antenna stations under control and aggregate and transfer the received signals; and
an aggregation station configured to receive the signal from one or more distributed stations under control and transfer the received signal to an upper network, the first transmission apparatus is the distributed station, and
the second transmission apparatus is the aggregation station.

5. The switching control apparatus according to claim 3, wherein a plurality of the transmission apparatus comprises
a plurality of antenna stations configured to convert a radio signal received from the terminal into a wired signal and transmit the converted signal;
a plurality of distributed stations configured to receive the signals from one or more antenna stations under control and aggregate and transfer the received signals; and
an aggregation station configured to receive the signal from one or more distributed stations under control and transfer the received signal to an upper network, the first transmission apparatus is the antenna station, and
the second transmission apparatus is the distributed station.

6. The switching control apparatus according claim 3, wherein the first transmission apparatus transmits the signal through an optical signal.

7. The switching control apparatus according to claim 3, wherein the switching control apparatus is notified of the allocation of the radio resources to the terminal each time the radio resources are allocated to the terminal.

8. The switching control apparatus according to claim 4, wherein the determiner determines whether or not congestion occurs in the second transmission apparatus using a processing capability of the second transmission apparatus, a processing amount in the second transmission apparatus, and the processing capability predicted for the second transmission apparatus.

9. The switching control apparatus according to claim 8, wherein the determiner calculates the processing capability of the second transmission apparatus on the basis of an amount of resources allocated to the second transmission apparatus.

10. The switching control apparatus according to claim 3, further comprising:
a future traffic amount calculator configured to calculate a future traffic amount serving as a traffic amount of the first transmission apparatus in a period next to the predetermined period on the basis of the traffic amount in the predetermined period,
wherein the required band calculator calculates, for each of the second transmission apparatuses, a processing capability predicted to be required in the second transmission apparatus, on the basis of the future traffic amount in the first transmission apparatus with the second transmission apparatus as a connection destination.

11. A switching control method comprising:
calculating a traffic amount of a signal received via a transmission apparatus of a layer lower than a predetermined layer among a plurality of layers configured to constitute a communication network hierarchized into a plurality of layers and transfer a received signal to a layer next above, in a predetermined period by a first transmission apparatus serving as a transmission apparatus of the predetermined layer, on the basis of allocation of radio resources to a terminal wirelessly transmitting a signal to a lowermost transmission apparatus among the plurality of transmission apparatuses;
calculating, for each second transmission apparatus serving as a transmission apparatus of a layer next above the first transmission apparatus, a processing capability predicted to be required in the second transmission apparatus on the basis of the traffic amount in the first transmission apparatus with the second transmission apparatus as a connection destination;
determining whether or not congestion occurs in the second transmission apparatus on the basis of the predicted processing capability;
determining to switch connection destinations of at least some of the first transmission apparatuses with the second transmission apparatus in which congestion is determined to occur as a connection destination, to the second transmission apparatus in which congestion is determined not to occur; and
instructing a transfer apparatus transferring a signal transmitted from the first transmission apparatus to the second transmission apparatus serving as the connection destination of the first transmission apparatus among the plurality of second transmission apparatuses to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination to switch the connection destinations.

12. A program for causing a computer to function as the switching control apparatus, the program making the computer perform:
calculate a traffic amount of a signal received via a transmission apparatus of a layer lower than a predetermined layer among a plurality of layers configured to constitute a communication network hierarchized into a plurality of layers and transfer a received signal to a layer next above, in a predetermined period by a first transmission apparatus serving as a transmission apparatus of the predetermined layer, on the basis of allocation of radio resources to a terminal wirelessly transmitting a signal to a lowermost transmission apparatus among the plurality of transmission apparatuses;
calculate, for each second transmission apparatus serving as a transmission apparatus of a layer next above the first transmission apparatus, a processing capability predicted to be required in the second transmission apparatus on the basis of the traffic amount in the first transmission apparatus with the second transmission apparatus as a connection destination;
determine whether or not congestion occurs in the second transmission apparatus on the basis of the predicted processing capability;
determine to switch connection destinations of at least some of the first transmission apparatuses with the second transmission apparatus in which congestion is determined to occur as a connection destination, to the second transmission apparatus in which congestion is determined not to occur; and
instruct a transfer apparatus transferring a signal transmitted from the first transmission apparatus to the second transmission apparatus serving as the connection destination of the first transmission apparatus among the plurality of second transmission apparatuses to transfer a signal transmitted from a switching target transmission apparatus serving as the first transmission apparatus whose connection destination is determined to be switched, to the second transmission apparatus serving as a connection destination after switching of the switching target transmission apparatus, on the basis of the determination to switch the connection destinations.

13. The switching control apparatus according to claim 4, wherein the first transmission apparatus transmits the signal through an optical signal.

14. The switching control apparatus according to claim 5, wherein the first transmission apparatus transmits the signal through an optical signal.

15. The switching control apparatus according to claim 4, wherein the switching control apparatus is notified of the allocation of the radio resources to the terminal each time the radio resources are allocated to the terminal.

16. The switching control apparatus according to claim 5, wherein the switching control apparatus is notified of the allocation of the radio resources to the terminal each time the radio resources are allocated to the terminal.

17. The switching control apparatus according to claim 6, wherein the switching control apparatus is notified of the allocation of the radio resources to the terminal each time the radio resources are allocated to the terminal.

18. The switching control apparatus according to claim 4, further comprising:
a future traffic amount calculator configured to calculate a future traffic amount serving as a traffic amount of the first transmission apparatus in a period next to the predetermined period on the basis of the traffic amount in the predetermined period,
wherein the required band calculator calculates, for each of the second transmission apparatuses, a processing capability predicted to be required in the second transmission apparatus, on the basis of the future traffic amount in the first transmission apparatus with the second transmission apparatus as a connection destination.

19. The switching control apparatus according to claim 5, further comprising:
a future traffic amount calculator configured to calculate a future traffic amount serving as a traffic amount of the first transmission apparatus in a period next to the predetermined period on the basis of the traffic amount in the predetermined period,
wherein the required band calculator calculates, for each of the second transmission apparatuses, a processing capability predicted to be required in the second transmission apparatus, on the basis of the future traffic amount in the first transmission apparatus with the second transmission apparatus as a connection destination.

20. The switching control apparatus according to claim 6, further comprising:
a future traffic amount calculator configured to calculate a future traffic amount serving as a traffic amount of the first transmission apparatus in a period next to the predetermined period on the basis of the traffic amount in the predetermined period,
wherein the required band calculator calculates, for each of the second transmission apparatuses, a processing capability predicted to be required in the second transmission apparatus, on the basis of the future traffic amount in the first transmission apparatus with the second transmission apparatus as a connection destination.
